(19) United States
(12) Patent Application Publication
(10) Pub. No.: US 2010/0317866 A1
(43) Pub. Date: Dec. 16, 2010

(54) IMIDAZOLE GROUP-CONTAINING PHOSPHORUS COMPOUNDS

(75) Inventors: Peter Hofmann, Heidelberg (DE); Patrick Hanno-Igels, Heidelberg (DE); Oleg Bondarev, Rennes (FR); Christoph Jaekel, Limburgerhof (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/867,545

(22) PCT Filed: Feb. 13, 2009
(86) PCT No.: PCT/EP2009/051677

§ 371 Date: Aug. 13, 2010

(30) Foreign Application Priority Data
Feb. 15, 2008 (EP) 08151496.0

(51) Int. Cl. C07F 15/00; C07F 9/6506

(52) U.S. Cl. 548/103; 548/112

(57) ABSTRACT

The present invention relates to phosphorus compounds containing imidazole groups, to optically active ligands prepared using them, to transition metal complexes which comprise such ligands, and to catalysts which comprise such transition metal complexes. The present invention further relates to the particular processes for preparing the phosphorus compounds, the optically active ligands, the transition metal complexes and the catalysts, and also to the use of the catalysts for organic transformation reactions.

The present invention relates to phosphorus compounds containing imidazole groups, to optically active ligands prepared using them, to transition metal complexes which comprise such ligands, and to catalysts which comprise such transition metal complexes. The present invention further relates to the particular processes for preparing the phosphorus compounds, the optically active ligands, the transition metal complexes and the catalysts, and also to the use of the catalysts for organic transformation reactions.

Organic transformation reactions, for example asymmetric hydrogenations, hydroformylations or polymerizations, are important reactions in the industrial scale chemical industry. These organic transformation reactions are predominantly catalyzed homogeneously.

In order to obtain catalysts with high activity and enantioselectivity, complicated, multistage and hence costly syntheses frequently have to be carried out. Usually, the syntheses of the ligands by which the reactivity of the metal complexes can be tailored are the most difficult step. The search for ligands which are based on readily available starting material and/or are preparable by a simple synthesis method is consequently a permanent task in reducing costs in chemical catalysis.

In order, for example, to be able to control the stereoselectivity in an asymmetric hydrogenation or the tacticity in a polymerization, chiral ligands are required. One starting skeleton for chiral ligands might be NHCP ligands, which have potential by virtue of a sterically protected phosphorus atom and a carbene as a strong σ-donor.

In spite of this starting basis, the prior art has to date only disclosed achiral and a few chiral NHCP ligands. In Organometallics 2007, Volume 26, pages 253 to 263, in Chemistry-A European Journal 2007, Volume 13, pages 3652 to 3659, in Journal of Organometallic Chemistry 2005, Volume 690, pages 5948 to 5958 and in Organometallics 2003, Volume 22, pages 4750 to 4758, for example, achiral NHCP ligands of the following type are described:

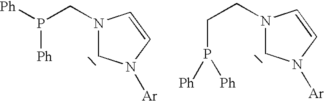

where “Ph” represents phenyl and “Ar” 2,6-diisopropylphenyl or 2,4,6-trimethylphenyl. Applications of these systems in catalytic transformations are described in Organic Letters 2001, Volume 3, pages 1511 to 1514, Advanced Synthesis & Catalysis 2004, Volume 346, pages 595 to 598, Inorganica Chimica Acta 2004, Volume 357, pages 4313 to 4321, Journal of Organometallic Chemistry 2006, Volume 691, pages 433 to 443, and Organometallics 2005, Volume 24, pages 4241 to 4250.

Only a few chiral NHCP ligands have been described to date; for instance, the prior art ((a) S, Nanchen, A. Pfaltz//Helvetica Chimica Acta 89 (2006) 1559-1573, (b) E. Bappert, G. Helmchen//Synlett 10 (2004)1789-1793, (c) H. Lang, J. Vittal, P-H. Leung//Journal of the Chemical Society, Dalton Transactions (1998) 2109-2110) discloses ligands which feature an ethano bridge between the phosphorus atom and the nitrogen atom of the imidazole group element. Further NHCP ligands have been described in the following literature ((a) H Seo, H. Park, B. Y. Kim, J. H. Lee, S. U. Son, Y. K. Chung//Organometallics (22) 2003, 618-620, (b) T. Focken, G. Raabe, C. Bolm//Tetrahedron: Asymmetry 15 (2004) 1693-1706, (c) T. Focken, J. Rudolph, C. Bolm//Synthesis (2005) 429-436, (d) R. Hodgson, R. E. Douthwaite//Journal of Organometallic Chemistry 690 (2005) 5822-5831). In this case too, a relatively long bridge has been selected between the phosphorus atom and a nitrogen atom of the imidazole group element. However, all chiral NHCP ligands described to date exhibit only moderate enantioselectivities.

In addition, the prior art (WO 03/022812 A1; WO 2006/087333 A1; WO 03/037835 A2; EP 1 182 196 A1) discloses ionic liquids which comprise the following imidazolium cations and are of the following formula, but these do not comprise any NHCP combinations:

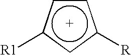

where the R1 radical is selected from the group consisting of a) hydrogen, b) linear or branched, saturated or unsaturated, aliphatic or alicyclic alkyl groups having from 1 to 20 carbon atoms, c) heteroaryl, heteroaryl-C₁-C₆-alkyl groups having from 3 to 8 carbon atoms in the heteroaryl radical and at least one heteroatom which is selected from N, O and S and may be substituted by at least one group selected from C₁-C₆-alkyl groups and/or halogen atoms, d) aryl, aryl-C₁-C₆-alkyl groups which have from 5 to 16 carbon atoms in the aryl radical and may optionally be substituted by at least one C₁-C₆-alkyl group and/or a halogen atom, and the R radical is selected from the group consisting of a) linear or branched, saturated or unsaturated, aliphatic or alicyclic alkyl groups having from 1 to 20 carbon atoms, b) heteroaryl-C₁-C₆-alkyl groups having from 3 to 8 carbon atoms in the heteroaryl radical and at least one heteroatom which is selected from N, O and S and may be substituted by at least one group selected from C₁-C₆-alkyl groups and/or halogen atoms, c) aryl-C₁-C₆-alkyl groups which have from 5 to 16 carbon atoms in the aryl radical and may optionally be substituted by at least one C₁-C₆-alkyl group and/or a halogen atom.

The documents cited disclose various preparation methods for the ionic liquids described. It is also stated that the ionic liquids can be used as solvents, as phase transfer catalysts, as extractants, as heat carriers, as operating fluid in process or working machines, or as an extraction medium or as a constituent of the reaction medium for extractions of polarizable impurities/substrates.

It is accordingly an object of the present invention to provide novel optically active ligands and catalysts based thereon. These ligands should be synthesizable with industrially inexpensively available starting materials and reagents and without considerable apparatus complexity. The ligands or the catalyst should preferably be preparable in a one-stage process. In particular, both enantiomers of the particular ligands should be preparable with similar efficiency. Moreover, the ligands or the catalysts prepared therefrom should be suitable for use in organic transformation reactions with high stereoselectivity and/or good regioselectivity. Furthermore, the organic transformation reactions should have a yield comparable to the prior art.

It has been found that, surprisingly, the catalysts prepared from the NHCP ligands characterized in detail below have a good efficiency compared to the prior art with significantly lower synthesis costs. The NHCP ligands are not only simple and inexpensive to prepare, but are also exceptionally robust. Moreover, it is even possible to prepare both enantiomers with a low level of complexity.

For the purpose of illustrating the present invention, the expression “alkyl” comprises straight-chain and branched alkyl groups. They are preferably straight-chain or branched C₁-C₂₀-alkyl, more preferably C₁-C₁₂-alkyl, especially preferably C₁-C₈-alkyl and very especially preferably C₁-C₄-alkyl groups. Examples of alkyl groups are especially methyl, ethyl, propyl, isopropyl, n-butyl, 2-butyl, sec-butyl, tert-butyl, n-pentyl, 2-pentyl, 2-methylbutyl, 3-methylbutyl, 1,2-dimethylpropyl, 1,1-dimethylpropyl, 2,2-dimethylpropyl, 1-ethylpropyl, n-hexyl, 2-hexyl, 2-methylpentyl, 3-methylpentyl, 4-methylpentyl, 1,2-dimethylbutyl, 1,3-dimethylbutyl, 2,3-dimethylbutyl, 1,1-dimethylbutyl, 2,2-dimethylbutyl, 3,3-dimethylbutyl, 1,1,2-trimethylpropyl, 1,2,2-trimethylpropyl, 1-ethylbutyl, 2-ethylbutyl, 1-ethyl-2-methylpropyl, n-heptyl, 2-heptyl, 3-heptyl, 2-ethylpentyl, 1-propylbutyl, n-octyl, 2-ethylhexyl, 2-propylheptyl, nonyl, decyl.

The expression “alkyl” also comprises substituted alkyl groups which have generally 1, 2, 3, 4 or 5, and preferably 1, 2 or 3 substituents and more preferably 1 substituent. These are preferably selected from alkoxy, cycloalkyl, aryl, hetaryl, hydroxyl, halogen, NE¹E², NE¹E²E³⁺, carboxylate and sulfonate. A preferred perfluoroalkyl group is trifluoromethyl.

In the context of the present invention, the expression “aryl” comprises unsubstituted and also substituted aryl groups, and is preferably phenyl, tolyl, xylyl, mesityl, naphthyl, fluorenyl, anthracenyl, phenanthrenyl or naphthacenyl, more preferably phenyl or naphthyl, where these aryl groups, in the case of substitution, may generally bear 1, 2, 3, 4 or 5 and preferably 1, 2 or 3 substituents and more preferably 1 substituent, selected from the groups of alkyl, alkoxy, carboxylate, trifluoromethyl, sulfonate, NE¹E², alkylene-NE¹E², nitro, cyano and halogen. A preferred perfluoroaryl group is pentafluorophenyl.

In the context of this invention, carboxylate and sulfonate preferably represent a derivative of a carboxylic acid function and of a sulfonic acid function respectively, especially a metal carboxylate or sulfonate, a carboxylic ester or sulfonic ester function or a carboxamide or sulfonamide function. These include, for example, the esters with C₁-C₄-alkanols such as methanol, ethanol, n-propanol, isopropanol, n-butanol, sec-butanol and tert-butanol.

The above illustrations of the terms “alkyl” and “aryl” apply correspondingly to the terms “alkoxy” and “aryloxy”.

In the context of the present invention, the term “acyl” represents alkanoyl or aroyl groups having generally from 2 to 11 and preferably from 2 to 8 carbon atoms, for example the formyl, acetyl, propanoyl, butanoyl, pentanoyl, hexanoyl, heptanoyl, 2-ethylhexanoyl, 2-propylheptanoyl, benzoyl or naphthoyl group.

The E¹ to E³ radicals are each independently selected from hydrogen, alkyl, cycloalkyl and aryl. The NE¹E² group is preferably N,N-dimethylamino, N,N-diethylamino, N,N-dipropylamino, N,N-diisopropylamino, N,N-di-n-butylamino, N,N-di-t-butylamino, N,N-dicyclohexylamino or N,N-diphenylamino.

Halogen represents fluorine, chlorine, bromine and iodine, preferably fluorine, chlorine and bromine.

In the context of the invention, the term “leaving group” represents those structural elements which can be substituted by attack of or reaction with nucleophiles. These leaving groups are generally known to those skilled in the art and, for example, chlorine, bromine, iodine, trifluoroacetyl, acetyl, benzoyl, tosyl, nosyl, triflate, nonaflate, camphor-10-sulfonate and the like are used.

In the description part of the present patent application, for simplification, both enantiomers are also included when only one enantiomer is specified.

The invention provides phosphorus compounds which contain imidazole groups and are of the general formula I or II:

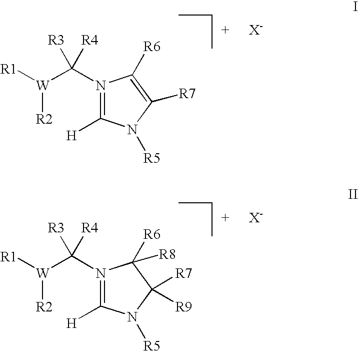

in which
W is phosphorus (P) or phosphite (P═O),
R1 and R2 are different radicals and are selected from the group consisting of alkyl and alkyl (variant α)
Or
R1 and R2 are different radicals and are selected from the group consisting of alkyl and aryl (variant β),
or
R1 and R2 together with W form a chiral 7-membered ring selected from the general formulae 1 to 6 (variant γ):

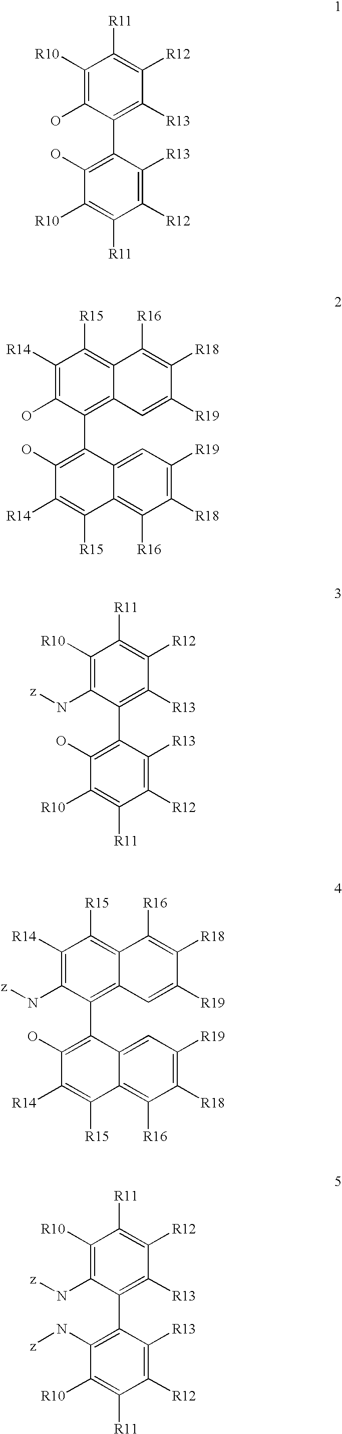

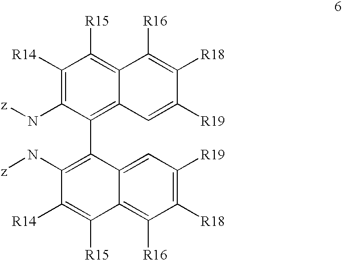

in which
R10 to R19 are each identical or different radicals and are selected from the group consisting of alkyl, aryl, alkoxy, aryloxy, acyloxy, hydroxyl, trialkylsilyl, sulfonyl, dialkylamino, acylamino, fluorine, chlorine, bromine and iodine, or, with regard to the R12 and R13 radicals:
the adjacent R12 and R13 radicals in each case form a 5- to 6-membered saturated ring, where the 5- to 6-membered ring, as well as carbon atoms, may also comprise nitrogen or oxygen atoms in the ring skeleton,
or, in relation to the R13 radicals:
the two R13 radicals form a 7- to 12-membered ring,
z in each case represents identical or different radicals and is selected from the group consisting of hydrogen, alkyl, acetyl, trifluoroacetyl, benzoyl, tosyl and nosyl,
Or
R1 and R2 together with W form a chiral 5-membered ring selected from the general formulae 7 to 9 (variant δ):

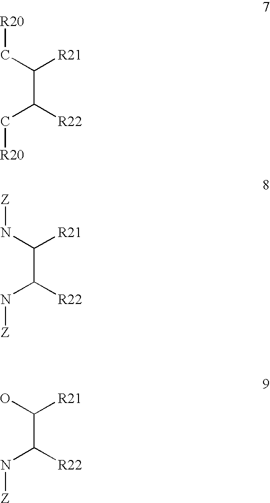

in which
R20 is a radical selected from the group consisting of methyl, ethyl, propyl, butyl, isopropyl and phenyl,
R21 and R22 are each identical or different radicals and are selected from the group consisting of hydrogen, alkyl, aryl and alkoxy
or R21 and R22 form a 4- to 6-membered ring which, as well as carbon atoms, may have up to two oxygen atoms in the ring skeleton,
z in each case represents identical or different radicals and is selected from the group consisting of hydrogen, alkyl, acetyl, trifluoroacetyl, benzoyl, tosyl and nosyl,
R3 and R4 are each identical or different radicals selected from the group consisting of hydrogen, alkyl and aryl,
R5 is alkyl or aryl,
R6 and R7 are each identical or different radicals selected from the group consisting of hydrogen, alkyl, aryl and a 6-membered aliphatic or aromatic ring,
R8 and R9 are each independently hydrogen or alkyl,
X is a leaving group.
W is preferably phosphorus.

In the case in which the R1 and R2 radicals are a combination of alkyl and alkyl (variant α), one alkyl radical is preferably adamantyl, tert-butyl, sec-butyl or isopropyl, especially tert-butyl, and the other alkyl radical is methyl, ethyl, propyl, butyl, pentyl or hexyl, especially methyl or ethyl, more preferably methyl.

In the case in which the R1 and R2 radicals are a combination of aryl and alkyl (variant β), the aryl radical is preferably phenyl, tolyl, xylyl, mesityl, naphthyl, fluorenyl, anthracenyl, especially phenyl, and the alkyl radical is methyl, adamantyl, tert-butyl, sec-butyl, isopropyl, especially tert-butyl and methyl.

The combination of alkyl and alkyl (variant α) is preferred over the combination of alkyl and aryl (variant β).

In the case in which the R1 and R2 radicals together with W form a chiral 7-membered ring (variant γ):
R10 to R19 are preferably each identical or different radicals selected from the group consisting of alkyl, especially methyl, ethyl, isopropyl, tert-butyl, adamantyl, alkoxy, especially methoxy, ethoxy, isopropoxy, tert-butyloxy, adamantyloxy, hydroxyl, chlorine, bromine and hydrogen, more preferably each independently hydroxyl, bromine and hydrogen,
R12 and R13 are each independently preferably dialkylamino, especially N,N-dimethylamino, N,N-diethylamino, N,N-diisopropylamino, N,N-dicyclohexylamino or N,N-diphenylamino, or acylamino, especially formylamino, acetylamino, propanoylamino, butanoylamino, pentanoylamino, benzoylamino, naphthoylamino, more preferably each independently formylamino, acetylamino, propanoylamino, butanoylamino, benzoylamino,
it is also preferred that the adjacent R12 and R13 radicals are each a 5- to 6-membered saturated ring, where the 5- to 6-membered ring, as well as from 3 to 4 carbon atoms, also comprises 2 nitrogen or 2 oxygen atoms in the ring skeleton; it is particularly preferred when the nitrogen or oxygen atoms join the 5- to 6-membered ring to the diphenyl skeleton of the formula 1, 3 or 5,
and, moreover, it is preferred that the two R13 radicals form a 7- to 12-membered ring comprising at least two oxygen atoms in the ring skeleton.
z are preferably each independently alkyl, especially methyl, ethyl, isopropyl, tert-butyl, adamantyl, acetyl or tosyl.

In the case in which the R1 and R2 radicals together with W form a chiral 7-membered ring (variant γ), preference is given to the general formulae 1 to 4, especially formulae 1 and 2.

In the case in which the R1 and R2 radicals together with W form a chiral 5-membered ring (variant δ):
R20 is preferably methyl, ethyl, isopropyl or phenyl,
R21 and R22 are preferably each independently hydrogen or alkoxy, especially methoxy, ethoxy, isopropoxy and tert-butyloxy; additionally preferred is a 5-membered aliphatic ring with two oxygen atoms;
z is preferably alkyl, especially methyl, ethyl, isopropyl, tert-butyl, adamantyl, aryl, especially phenyl, tolyl, xylyl, mesityl, naphthyl, fluorenyl, anthracenyl, acetyl, benzoyl, benzyloxycarbonyl, tert-butyloxycarbonyl or tosyl.

In the case in which the R1 and R2 radicals together with W form a chiral 5-membered ring (variant δ), preference is given to the general formulae 7 and 8, especially 7.

Among the variants α to δ, particular preference is given to α and β.

R3 and R4 are preferably each independently hydrogen, methyl, ethyl or benzyl, especially hydrogen.

R5 is preferably methyl, ethyl, isopropyl, tert-butyl, adamantyl, mesityl, phenyl, tolyl, xylyl, naphthyl, fluorenyl, anthracenyl, especially methyl, isopropyl, tert-butyl, adamantyl and mesityl.

R6 and R7 are preferably each independently hydrogen or a 6-membered aromatic ring.

R8 and R9 are preferably each independently hydrogen, alkyl, especially methyl, ethyl, isopropyl, tert-butyl, adamantyl, a (CH₂)₄ chain or aryl, especially phenyl, tolyl, xylyl, mesityl, naphthyl, fluorenyl, anthracenyl. More preferably, R8 and R9 are each independently hydrogen, phenyl or a (CH₂)₄ chain.

Particular preference is given to either the two enantiomers or diastereomers derived from the enantiomeric form of the cation, and the enantiomers thereof, of the following phosphorus compounds containing imidazole groups:

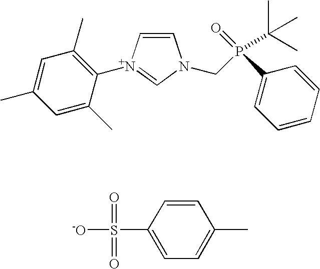

1-{[(S)-tert-butyl(phenyl)phosphoryl]methyl}-3-(2,4,6-trimethylphenyl)−1H-imidazol-3-ium tosylate

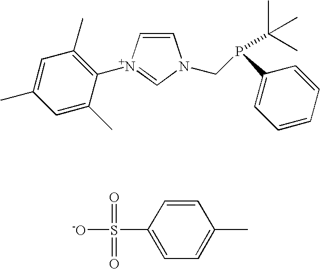

1-{[(R)-tert-butyl(phenyl)phosphanyl]methyl}-3-(2,4,6-trimethylphenyl)−1H-imidazol-3-ium tosylate

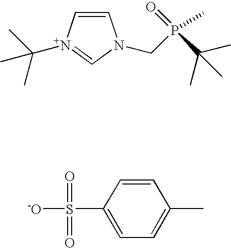

1-{[(S)-tert-butyl(methyl)]phosphoryl]methyl}-3-tert-butyl-1H-imidazol-3-ium tosylate

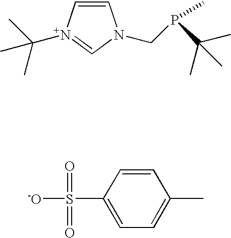

1-{[(R)-tert-butyl(methyl)]phosphanyl]methyl}-3-tert-butyl-1H-imidazol-3-ium tosylate

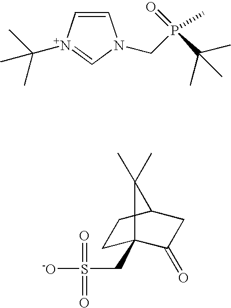

1-{[(S)-tert-butyl(methyl)phosphoryl]methyl}-3-tert-butyl-1H-imidazol-3-ium (1S)-camphor-10-sulfonate

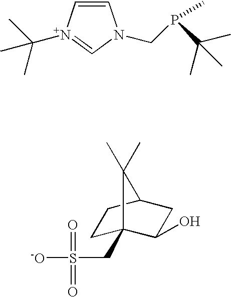

1-{[(R)-tert-butyl(methyl)phosphanyl]methyl}-3-tert-butyl-1H-imidazol-3-ium (1S)-isoborneol-10-sulfonate

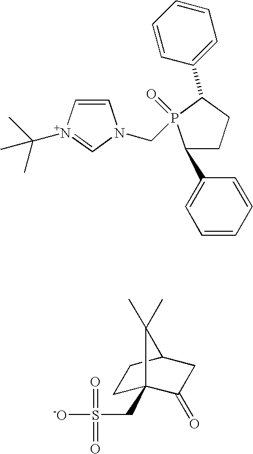

1-{[(S,S)−1-r-oxo-2-c,5-t-diphenylphospholan-1-yl]methyl}-3-tert-butyl-1H-imidazol-3-ium (1S)-camphor-10-sulfonate

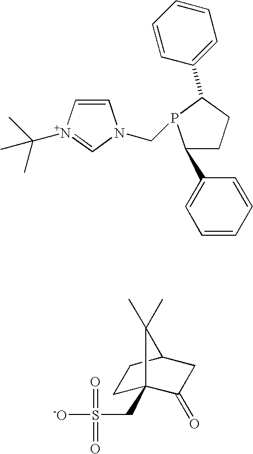

1-{[(S,S)−2-c,5-t-diphenylphospholan-1-yl]methyl}-3-tert-butyl-1H-imidazol-3-ium (1S)-camphor-10-sulfonate

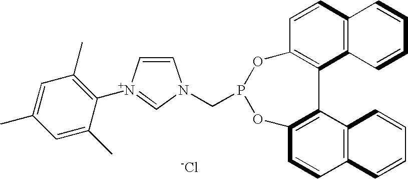

1-(4-methyl-(Rₐₓ)-dinaphtho[2,1-d:1′,2′-f][1,3,2]dioxaphosphepine)−3-(2,4,6-trimethylphenyl)−1H-imidazol-3-ium chloride

The present invention further relates to a process for preparing phosphorus compounds which contain imidazole groups and are of the general formula I or II, which comprises reacting compounds of the general formula A

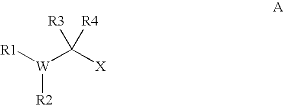

with compounds of the general formula B or C

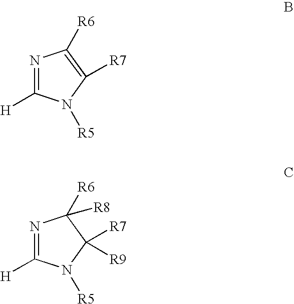

at a temperature of from 20 to 200° C. for several days, if appropriate using one or more solvents.

A reaction to give compound I is effected using compound B, and a reaction to give compound II using compound C.

Preference is given to performing the reaction at a temperature of from 50 to 150° C., especially at a temperature of from 80 to 120° C. The reaction time is typically from 1 to 10 days, preferably from 10 to 150 hours. The optimal reaction time can be determined by the person skilled in the art by simple routine tests. The solvents used may be all solvents known to those skilled in the art, for example toluene, xylene, acetonitrile; preferably, the compound B or C serves as the solvent.

The phosphorus compounds which contain imidazole groups and are of the general formula I and II serve as precursors for preparing optically active ligands (carbenes) of the general formulae III and IV:

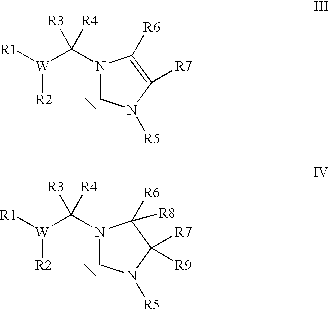

where the definitions and preferences of the R1 to R22, W and z radicals correspond to the preferences indicated above for the general formulae I and II at page 5 line 7 to page 13 line 8.

The invention therefore further provides optically active ligands of the general formula III:

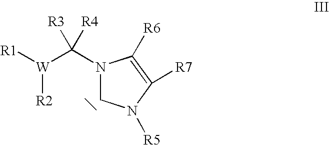

in which
W is phosphorus (P) or phosphite (P═O),
R1 and R2 are different radicals and are selected from the group consisting of alkyl and alkyl (variant α)
or
R1 and R2 are different radicals and are selected from the group consisting of alkyl and aryl (variant β),
Or
R1 and R2 together with W form a chiral 7-membered ring selected from the general formulae 1 to 6 (variant γ):

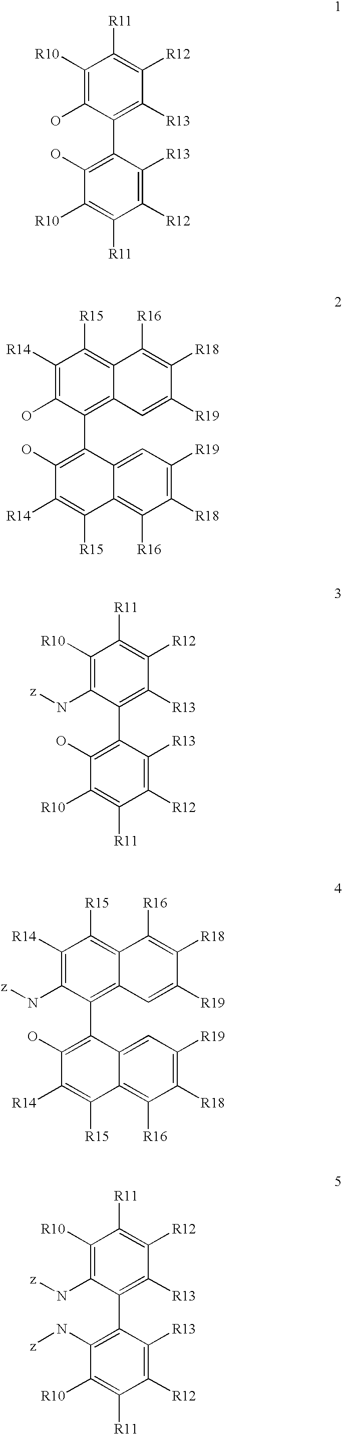

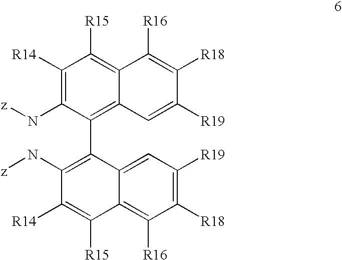

in which
R10 to R19 are each identical or different radicals and are selected from the group consisting of alkyl, aryl, alkoxy, aryloxy, acyloxy, hydroxyl, trialkylsilyl, sulfonyl, dialkylamino, acylamino, fluorine, chlorine, bromine and iodine, or, with regard to the R12 and R13 radicals:
the adjacent R12 and R13 radicals in each case form a 5- to 6-membered saturated ring, where the 5- to 6-membered ring, as well as carbon atoms, may also comprise nitrogen or oxygen atoms in the ring skeleton,
or, in relation to the R13 radicals:
the two R13 radicals form a 7- to 12-membered ring,
z in each case represents identical or different radicals and is selected from the group consisting of hydrogen, alkyl, acetyl, trifluoroacetyl, benzoyl, tosyl and nosyl,
Or
R1 and R2 together with W form a chiral 5-membered ring selected from the general formulae 7 to 9 (variant δ):

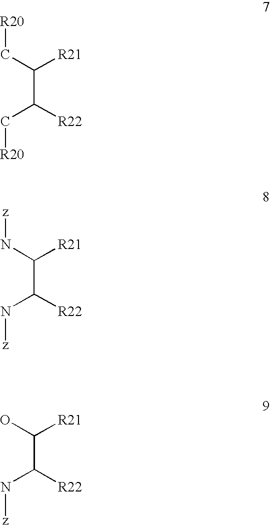

in which
R20 is a radical selected from the group consisting of methyl, ethyl, propyl, butyl, isopropyl and phenyl,
R21 and R22 are each identical or different radicals and are selected from the group consisting of hydrogen, alkyl, aryl and alkoxy
or R21 and R22 form a 4- to 6-membered ring which, as well as carbon atoms, may have up to two oxygen atoms in the ring skeleton,
z in each case represents identical or different radicals and is selected from the group consisting of hydrogen, alkyl, acetyl, trifluoroacetyl, benzoyl, tosyl and nosyl,
R3 and R4 are each identical or different radicals selected from the group consisting of hydrogen, alkyl and aryl,
R5 is alkyl or aryl,
R6 and R7 are each identical or different radicals selected from the group consisting of hydrogen, alkyl, aryl and a 6-membered aliphatic or aromatic ring.

The preferences of the R1 to R7 and R10 to R22, W and z radicals correspond to the preferences detailed above for the general formula I at page 8 line 3 to page 13 line 8.

Particular preference is given to both enantiomers of the following optically active ligands:

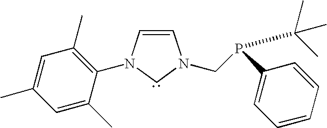

3-mesityl-1-(tert-butyl(phenyl)phosphinomethyl)imidazol-2-ylidene

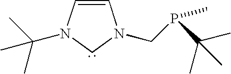

3-tert-butyl-1-(tert-butyl(methyl)phosphinomethyl)imidazol-2-ylidene

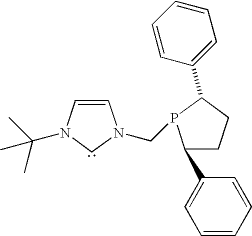

3-tert-butyl-11(2-c,5-t-diphenylphospholan-1-yl)methyl]-imidazol-2-ylidene

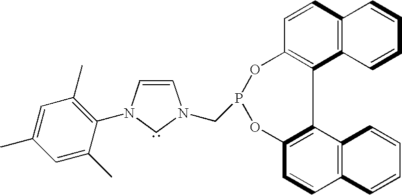

3-mesityl-1-(4-methyldinaphtho[2,1-d:1,2′-f][1,3,2]dioxaphosphepine)imidazol-2-ylidene

The invention further relates to a process for preparing compounds of the general formula III, which comprises converting compounds of the general formula I using in each case at least one strong base and an ethereal or other aprotic solvent at a temperature of from −80 to +20° C. to the compounds of the general formula III (step (ii)), if W is phosphite (P═O), reducing the compound of the general formula I before step (ii) in the presence of in each case at least one reducing agent, of a Lewis acid and of a solvent at a temperature of +20° C. to +100° C. for from 1 to 200 hours (step (i)).

In step (i), the reducing agent used is preferably a hydride donor, for example PMHS (polymethylhydrosiloxane), (EtO)₃SiH, HSiCl₃; H₃SiPh, AlH₃/Ti(OiPr)₄, AlH₃/TiCl₄, AlH₃/TiCp₂Cl2 (Cp=cyclopentadienyl), more preferably PMHS, (EtO)₃SiH or Ti(OiPr)₄.

Useful Lewis acids in step (i) include all Lewis acids known to those skilled in the art, for example TiCl₄, Ti(OiPr)₄ or TiCp₂Cl₂.

The solvent used in step (i) is preferably a stable solvent or mixtures of such solvents, for example ethereal, halogenated or aromatic solvents such as THF, diethyl ether, tert-butyl methyl ether, dibutyl ether, toluene, hexane, chlorobenzene, chloroform, preferably THF, diethyl ether, chlorobenzene, chloroform.

The reaction time of step (i) is typically from 5 to 100 hours, preferably from 10 to 50 hours. General information can be found, for example, in (a) T. Coumbe, N. J. Lawrence, F. Muhammad, Tetrahedron: Letters 1994, 35, 625-628; (b) Y. Hamada, F. Matsuura, M. Oku, K. Hatano, T. Shioiri, Tetrahedron: Letters, 1997, 38, 8961-8964 and (c) A. Ariffin, A. J. Blake, R. A. Ewin, W.-S. Li, N. S. Simpkins, J. Chem. Soc., Perkin Trans. 1, 1999, 3177-3189.

In step (ii), typical strong bases which are known to those skilled in the art and preferably have a pK_{B} of at least 14 are used. For example, KOt-Bu, KOEt, KOMe, KOH, NaOt-Bu, NaOEt, NaOMe, NaOH, LiOH, LiOtBu, LiOMe, especially KOt-Bu, KOEt, KOMe, NaOt-Bu, NaOEt, NaOMe, are used.

In step (ii), all ethereal or other aprotic solvents known to those skilled in the art can be used, for example diethyl ether, tert-butyl methyl ether, dibutyl ether, toluene or mixtures thereof.

The reaction time of step (ii) is typically from 1 minute to 10 hours, preferably from 10 minutes to 5 hours, especially from 2 to 3 hours.

The reaction temperature in step (ii) is preferably from −60 to 40° C., especially from −20 to 30° C.

The invention further relates to transition metal complexes comprising, as ligands, at least one compound of the general formula III or IV.

The transition metal complexes correspond to the general formulae V and VI:

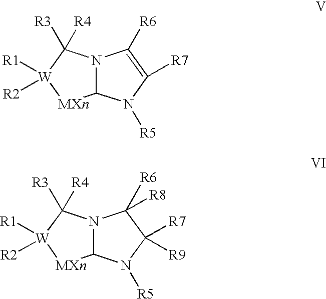

Preference is given to using, as transition metals (M), metals of groups 8 to 11, especially Ru, Fe, Co, Rh, Ir, Ni, Pd, Pt, Ag, Cu or Au, more preferably Ru, Rh, Ir, Ni, Pd.

X represents further ligands which may different, preferably cod (cyclooctadiene), norbornadiene, Cl, Br, I, CO, allyl, benzyl, Cp (cyclopentadienyl), PCy₃, PPh₃, MeCN, PhCN, dba (dibenzylideneacetone), acetate, CN, acac (acetylacetonate), methyl and H, especially cod, norbornadiene, Cl, CO, allyl, benzyl, acac, PCy₃, MeCN, methyl and H. n varies between 0 and 4 and is accordingly dependent on the transition metal selected.

The definitions and preferences for the R1 to R22, W and z radicals correspond to the preferences for the compounds of the general formulae III and IV, and the general formulae I and II, at page 5 line 7 to page 13 line 8.

The present invention further relates to a process for preparing transition metal complexes, which comprises either
(a) reacting optically active ligands of the general formula III with metal complexes at a temperature of from −80° C. to +120° C. using at least one solvent for from 5 minutes to 72 hours,
or
(b) reacting imidazole-containing phosphorus compounds of the formula I or II with metal complexes using in each case at least one strong base and an ethereal or other aprotic solvent at a temperature of from −80° C. to +120° C. for from 5 minutes to 72 hours,
if W is phosphite, in both cases (a) and (b), reducing in a separate preceding stage using in each case at least one reducing agent and a Lewis acid.

The selection of suitable metal complexes, especially their leaving ligands, can be undertaken by the person skilled in the art by routine tests. For example, useful metal complexes include [Ir(cod)Cl)]₂, [Rh(cod)Cl]₂, [Ir(norbornadiene)Cl]₂, [Rh(norbornadiene)Cl₂], Rh(cod)acac, [RhCl(C₈H₁₄)₂]₂, Rh(cod)(methallyl), Rh(cod)₂X, Rh(norbornadiene)₂X, Ir(cod)₂X (where X=BF₄, ClO₄, CF₃SO₃, CH₃SO₃; H,SO₄, B(phenyl)₄, B[bis(3,5-trifluoromethyl)phenyl]₄, PF₆, SbCl₆, AsF₆, SbF₆), Rh(OAc)₃ Rh(acac)(CO)₂, Rh₄(CO)₁₂, RhCl(PPh₃)₃, [RhCl(CO)₂]₂, RuCp₂, RuCp(CO)₃, [Rul₂(cymene)]₂, [RuCl₂(benzene)]₂ Ru(cod)(methallyl)₂, RuCl₂(PCy₃)₂CHPh, (PCy₃)Cl₂RuCl(OiPrO-Ph), RuCl₂(C₂₁H₂₄N₂)(C₁₆H₁₀)(PCy₃), [Pd(allyl)Cl]₂, Pd₂(dba)₃, Pd(dba)₂, Pd(PPh₃)₄, Pd(OAc)₂, PdCl₂(MeCN)₂, PdCl₂(PhCN)₂, Pd(cod)ClMe, Pd(tmeda)Me₂, Pt(cod)Me₂, Pt(cod)Cl₂, SnCl₂, CuCl, CuCl₂, CuCN, Cu(CF₃SO₃)₂, [Ni(allyl)Cl]₂, Ni(cod)₂. Preference is given to [Ir(cod)Cl]₂, [Rh(cod)Cl]₂, [Ir(norbornadiene)Cl]₂, [Rh(norbornadiene)Cl]₂, Rh(cod)acac, Rh(OAc)₃, Rh(cod)₂X, Rh(norbornadiene)₂X, Ir(cod)₂X (where X=BF₄, CIO₄, CF₃SO₃, CH₃SO₃; H,SO₄, B(phenyl)₄, B[bis(3,5-trifluoromethyl)phenyl]₄, PF₆, SbCl₆, AsF₆, SbF₆), Rh(acac)(CO)₂, [RhCl(CO)₂]₂, RuCp2, RuCp(CO)₃, [RuCl₂(cymene)]₂, RuCl₂(PCy₃)₂CHPh, (PCy₃)Cl₂RuCl(OiPrO-Ph), Ru(cod)(methallyl)₂, [Pd(allyl)Cl]₂, Pd₂(dba)₃, CuCN, Cu(CF₃SO₃)₂, [Ni(allyl)Cl]₂, Ni(cod)₂, especially [Ir(cod)Cl]₂, [Rh(cod)Cl]₂, Rh(cod)acac, Rh(cod)₂X, Rh(norbornadiene)₂X, Ir(cod)₂X (where X=BF₄, ClO₄, CF₃SO₃, CH₃SO₃, HSO₄, B(phenyl)₄, B[bis(3,5-trifluoromethyl)phenyl]₄, PF₆, SbCl₆, AsF₆, SbF₆), Rh(acac)(CO)₂, [RuCl₂(cymene)]₂, RuCl₂(PCy₃)₂CHPh, Ru(cod)(methallyl)₂, [Pd(allyl)Cl]₂, Cu(CF₃SO₃)₂, [Ni(allyl)Cl]₂, Ni(cod)₂.

In option (a), the reaction temperature is advantageously from −80° C. to +120° C., preferably from 0° C. to +50° C. The reaction time is advantageously from 5 minutes to 72 hours, preferably from 1 to 24 hours. The solvents used may be all solvents familiar to those skilled in the art, for example THF, diethyl ether, hexane, pentane, CHCl₃, CH₂Cl₂, toluene, benzene, DMSO or acetonitrile; preference is given to THF, diethyl ether, CH₂Cl₂, toluene or hexane.

In option (b), the preferences in relation to the strong base and the ethereal or other aprotic solvent correspond to those described for step (ii) on page 20. In option (b), the reaction temperature is advantageously from −80° C. to +120° C., preferably from 0° C. to +50° C. The reaction time is advantageously from 5 minutes to 72 hours, preferably from 1 to 24 hours.

The present invention further relates to catalysts comprising at least one complex with a transition metal which comprises, as ligands, at least one compound of the general formula III or IV.

Preference is given to transition metals of groups 8 to 11, especially Ru, Fe, Co, Rh, Ir, Ni, Pd, Pt, Ag or Au, more preferably Ru, Rh, Ir, Ni or Pd.

The preferred ligands of the general formula III or IV are described on pages 15 to 19 (formula III) and also on pages 5 to 13 (formula IV).

Preference is given to the following catalysts, which are preparable either (variant 1) by reacting imidazole-containing phosphorus compounds of the formula I or II with metal complexes using in each case at least one strong base and an ethereal or other aprotic solvent at a temperature of from −80° C. to +120° C. for from 5 minutes to 72 hours,
if W is phosphite, reducing the compounds of the general formula I in a separate preceding stage using in each case at least one reducing agent and a Lewis acid, or
(variant 2) by reacting optically active ligands of the general formula III with metal complexes at a temperature of from −80° C. to +120° C. using at least one ethereal or other aprotic solvent for from 5 minutes to 72 hours,
if W is phosphite, the compounds of the general formula III are reduced in a separate preceding stage using in each case at least one reducing agent and a Lewis acid, or
(variant 3) by dissolving the transition metal complexes of the formula V or VI in at least one solvent.

Particular preference is given to variant (a). This variant represents the possibility of in situ synthesis of homogeneous catalysts.

The preferred reaction parameters of variants 1 and 2 can be found at page 21, lines 34 to 39 (variant 1) and page 21 line 41 to page 22 line 3 (variant 2).

The invention further provides for the use of catalysts comprising at least one complex with a transition metal, which comprises at least one compound of the general formula III or IV as a ligand—as described above—for organic transformation reactions. Organic transformation reactions are understood to mean, for example, hydrogenation, hydroboration, hydroamination, hydroamidation, hydroalkoxylation, hydrovinylation, hydroformylation, hydrocarboxylation, hydrocyanation, hydrosilylation, carbonylation, cross-coupling, allylic substitution, aldol reaction, olefin metathesis, C—H activation or polymerization.

Particular preference is given to the use of catalysts comprising transition metal complexes comprising, as ligands, at least one compound selected from the group consisting of 3-mesityl-1-(tert-butyl(phenyl)phosphinomethyl)imidazol-2-ylidene, 3-tert-butyl-1-(tert-butyl(methyl)phosphinomethyl)imidazol-2-ylidene, 3-tert-butyl-1-[(2-c,5-t-diphenylphospholan-1-yl)methyl]imidazol-2-ylidene and 3-mesityl-1-(4-methyldinaphtho[2,1-d:1′,2′-f][1,3,2]dioxaphosphepine)imidazol-2-ylidene for the asymmetric hydrogenation of unsaturated organic compounds.

The present invention can thus provide very inexpensive ligands whose efficiency is comparable to the prior art.

A particularly advantageous possibility is that of preparing homogeneous catalysts of different enantiomers comprising robust carbene units.

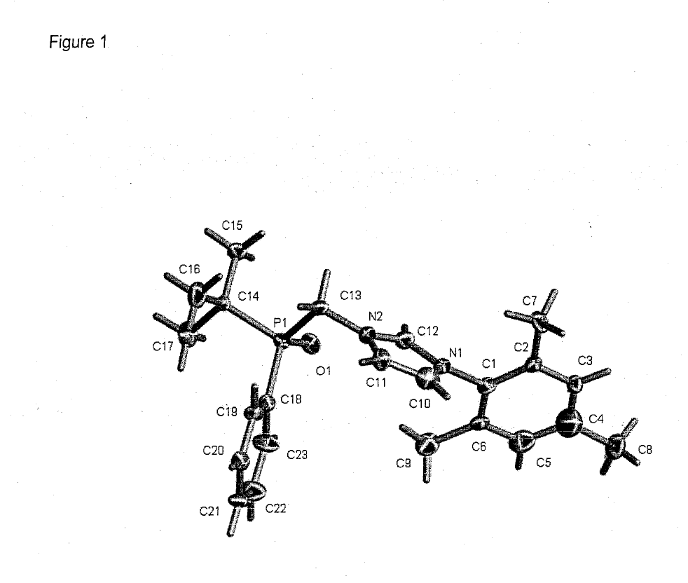

FIG. 1 shows the X-ray structure analysis of 1-{[(S)-tert-butyl(phenyl)phosphoryl]-methyl}-3-(2,4,6-trimethylphenyl)−1H-imidazol-3-ium tosylate.

### EXAMPLES

### 1) Synthesis of Phosphorus Compounds Containing Imidazole Groups of the Formula I

1.1) Synthesis of (R_{P})- and (S_{P})−3-mesityl-1-[(tert-butyl(phenyl)phosphino)methyl]-imidazolium tosylate 8

### 1.1.1) N-tert-Butylimidazole 1 and N-mesitylimidazole 2

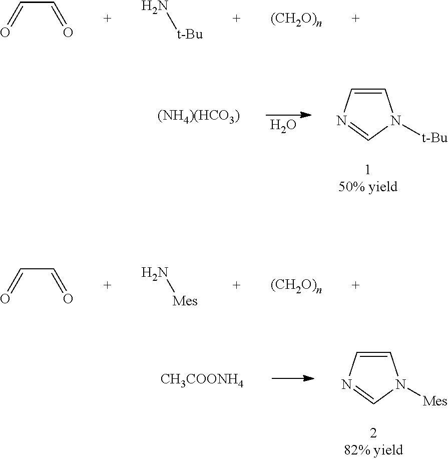

N-tert-Butylimidazole (1) and N-mesitylimidazole (2) were synthesized by literature method. [A. J. Arduengo, III et al. U.S. Pat. No. 6,177,575 B1]
1.1.2) (S_{P})- and (R_{P})-tert-Butyl(phenyl)phosphine oxide 3
1.1.2.1) (S_{P})-tert-Butyl(phenyl)phosphine oxide (S_{P})−3

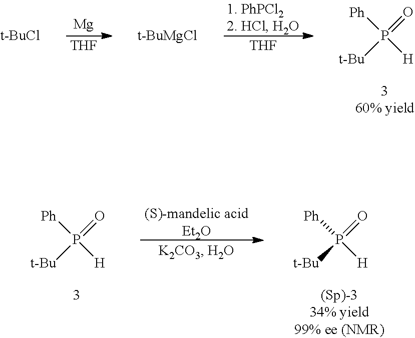

Racemic tert-butyl(phenyl)phosphine oxide (3) was synthesized via a Grignard reaction. [R. K. Haynes, T-L. Au-Yeung, W-K. Chan, W-L. Lam, Z-Y Li, L-L Yeung, A. S. C. Chan, P. Li, M. Koen. C R. Mitchell, S. C. Vonwiller, Eur. J. Org. Chem., 2000, 3205-3216.] The chiral tert-butyl(phenyl)phosphine oxide was obtained by crystallization of the phosphine oxide-(+)-(S)-mandelic acid adduct. [J. Drabowicz, P. Lyzwa, J. Omelanczuk, K. M. Pietrusiewicz, M. Mikolajczyk, Tetrahedron: Asymmetry 1999, 10, 2757-2763.]

1.1.2.2 (R_{P})-tert-Butyl(phenyl)phosphine oxide ((R_{P})−3)-optical resolution of racemic tert-butylphenylphosphine oxide with (−)-(R)-mandelic acid

To a solution of 18.4 g (0.1 mol) of racemic tert-butyl(phenyl)phosphine oxide (3) in 100 ml of diethyl ether were added, in portions, 15.2 g (0.1 mol) of (−)-(R)-mandelic acid. After a short time, a large amount of white solid formed. The reaction mixture was stirred at room temperature for 2 days. The precipitate was filtered off through a frit and dried. The NMR spectra showed only one diastereomer.

Yield 11.00 g, 33%; ³¹P NMR (CDCl₃), δ_{P}=49.77 (s). ¹H NMR (CDCl₃) δ_{H} (J_{H,P}), Hz) 1.116 (d, J=17.0, 9H), 5.153 (s, 1H), 7.01 (d, J=463.7, 1H), 7.25-7.75 (m, 10H).

5.5 g (16.5 mmol) of the mandelic acid adducts were admixed with 40 ml of a 5% aqueous K₂CO₃ solution. The phases were separated in a separating funnel and the aqueous phase was extracted repeatedly with chloroform. The combined organic phases were dried over magnesium sulfate, and the solvent was removed under reduced pressure to obtain optically active (R_{P})-tert-butyl(phenyl)phosphine oxide ((R_{P})−3) with a yield of 2.7 g (30% based on the adjusted amount of the racemic tert-butyl(phenyl)phosphine oxide (3) used).

1.1.3) (S_{P})-tert-Butyl(hydroxymethyl)(phenyl)phosphine oxide (S_{P})−4

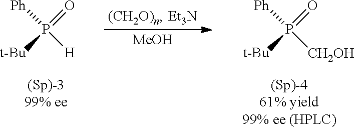

Under an argon atmosphere, 2.61 g (14.3 mmol) of (S_{P})-tert-butyl(phenyl)phosphine oxide ((S_{P})−3), 20 ml (143 mmol) of triethylamine and 2.0 g (66.6 mmol) of dried paraformaldehyde were dissolved in 30 ml of methanol (abs.) in a 250 ml three-neck flask with reflux condenser and pressure release valve. The reaction mixture was stirred at 60° C. for 8 hours. Subsequently, the solution was concentrated to dryness on a rotary evaporator and taken up again in chloroform. The organic phase was washed twice with 20 ml each time of 5% sulfuric acid and once with 20 ml of water. The organic phases were dried over MgSO₄ and concentrated on a rotary evaporator. Yield: 1.85 g, 61%; colorless solid; ³¹P NMR (CDCl₃), δ_{P}=47.3. ¹³C NMR (CDCl₃), δ_{C} (J_{C,P}), Hz) 24.6 (s, 3C; PC(CH₃)₃), 32.5 (d, ¹J=64.8, PC(CH₃)₃), 57.4 (d, J=72.3, PCH₂O), 128.3 (d, J=11.0, 2C; CH_{Ar}), 128.4 (d, J=85.3, C_{q,Ar}), 131.7 (d, J=8.0, 2C; CH_{Ar}), 131.8 (d, J=2.5, CH_{Ar}). ¹H NMR (CDCl₃), δ_{H} (J_{H, H} and J_{H,P}), Hz) 1.18 (d, J=14.3, 9H; PtBu), 4.28 (dd, J=2.8, J=14.5, 1H; PCH₂O), 4.47 (dd, J=2.2, J=14.4, 1H; PCH₂O), 5.18 (bs, 1H; OH), 7.34-7.71 (m, 5H; CH_{Ar}). HPLC Chiralpak IA, hexane/l-PrOH=97/3, 0.7 ml/min, tr₁=34.90, tr₂=36.11. HRMS (ESI⁺): calc. m/z 213.10389 (C₁₁H₁₈O₂P); found m/z 213.10389. Elemental analysis: calc. (%) for C₁₁H₁₇O₂P C 62.25; H, 8.07; found C. 62.19; H, 8.04.

1.1.4 (S_{P})-[tert-Butyl(phenyl)phosphinooxymethyl] (1S)-camphor-10-sulfonate (S_{P})−5

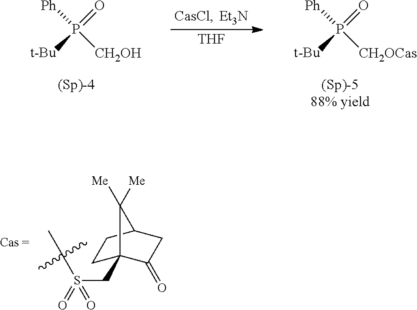

Under an argon atmosphere, a 500 ml three-neck flask with a dropping funnel and pressure release valve was initially charged with 5.30 g (25 mmol) of (S_{P})-tert-butyl(hydroxymethyl)(phenyl)phosphine oxide ((S_{P})−4) and 6.25 ml (44.8 mmol) of triethylamine (abs.) in 80 ml of tetrahydrofuran (abs.), and cooled to −15° C. A solution of 9.40 g (37.5 mmol) of (1S)-camphor-10-sulfonyl chloride in 40 ml of tetrahydrofuran (abs.) was added dropwise. The reaction suspension was stirred at room temperature overnight. 100 ml of dichloromethane and 50 ml of water were added to the reaction mixture, and the phases were separated in a separating funnel. The aqueous phase was extracted repeatedly with dichloromethane, and the combined organic phases were dried over sodium sulfate, filtered and concentrated on a rotary evaporator. After drying under fine vacuum, a colorless oil was obtained as the crude product, which was purified by column chromatography (SiO₂, Et₂O/EtOH=10/1).

Yield: 9.34 g, 88%; colorless solid; ³¹P NMR (CDCl₃), δ_{P}=41.3. ¹³C NMR (CDCl₃), δ_{C} (J_{C,P}), Hz) 19.6 (s, CH₃), 19.6 (s, CH₃), 24.4 (s, 3C; PC(CH₃)₃), 24.8 (s, CH₂), 26.9 (s, CH₂), 33.3 (d, J=68.8, PC(CH₃)₃), 42.4 (s, CH₂), 42.7 (s, CH), 47.5 (s, SCH₂), 48.1 (s, C_{q}), 57.8 (s, C_{q}), 62.5 (d, J=69.3, PCH₂O), 127.5 (d, J=90.8, C_{q,Ar}), 128.5 (d, J=10.8, 2C; CH_{Ar}), 131.8 (d, J=8.1, 2C; CH_{Ar}), 132.4 (d, J=2.2, CH_{Ar}), 214.0 (s, C_{q}). ¹H NMR (CDCl₃), δ_{H}(J_{H,H} and J_{H,P}), Hz) 0.85 (s, 3H; CH₃), 1.04 (s, 3H; CH₃), 1.23 (d, J=15.2, 9H; PtBu), 1.35-1.43 (m, 1H; CH₂), 1.58-1.66 (m, 1H; CH₂), 1.93 (d, J=18.2, 1H; CH₂), 1.94-2.02 (m, 1H; CH₂), 2.09 (t, J=4.3, 1H; CH), 2.23-2.31 (m, 1H; CH₂), 2.33-2.41 (m, 1H; CH₂), 3.13 (d, J=15.0, 1H; SCH₂), 3.67 (d, J=15.2, 1H; SCH₂), 4.98 (dd, J=5.5, J=13.2, 1H; PCH₂O), 4.93 (dd, J=2.9, J=13.0, 1H; PCH₂O), 7.48-7.62 (m, 3H; CH_{Ar}), 7.76-7.83 (m, 2H; CH_{Ar}). HPLC Chiralpak IA, hexane/l-PrOH=85/15, 1.0 ml/min, tr_{1=15.33}, tr_{2=25.82}. HRMS (ESI⁺): calc. m/z 427.17026 (C₂₁H₃₂O₅PS); found m/z 427.17052. Elemental analysis: calc. (%) for C₂₁HA₃₁O₅PS C 59.14; H, 7.33; found C. 58.98; H, 7.27.

1.1.5) (S_{P})-tert-Butyl(phenyl)(tosylmethyl)phosphine oxide (S_{P})−6

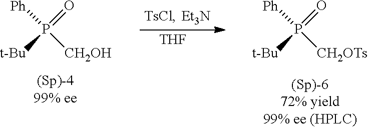

Under an argon atmosphere, a 250 ml three-neck flask with a dropping funnel and pressure release valve was initially charged with 2.12 g (10 mmol) of (S_{P})-tert-butyl(hydroxymethyl)(phenyl)phosphine oxide ((S_{P})−4) in 40 ml of tetrahydrofuran (abs.) and 2.09 ml (15 mmol, 1.5 eq.) of triethylamine (abs.), and cooled to −10° C. A solution of 2.38 g (12.5 mmol) of tosyl chloride in 10 ml of tetrahydrofuran (abs.) was added dropwise while stirring over 20 minutes. The reaction suspension was stirred at room temperature overnight. 50 ml of dichloromethane and 25 ml of water were added to the reaction mixture, and the phases were separated in a separating funnel. The aqueous phase was extracted repeatedly with dichloromethane. The combined organic phases were washed with 50 ml of saturated sodium chloride solution, dried over sodium sulfate, filtered and concentrated on a rotary evaporator. The crude product was purified by column chromatography (SiO₂, CH₂Cl₂/EtOH=15/1). Yield: 2.65 g, 72%; colorless solid; ³¹P NMR (CDCl₃), δ_{P}=40.9. 13C ¹³C NMR (CDCl₃), δ_{C} (J_{C,P}), Hz) 21.7 (s, CH₃), 24.3 (s, 3C; PC(CH₃)₃), 33.5 (d, J=68.8, PC(CH₃)₃), 63.4 (d, J=69.9, PCH₂O), 127.8 (d, J=90.8, C_{q,Ar}), 128.3 (s, 2C; CH_{Ar}), 128.5 (d, J=11.3, 2C; CH_{Ar}), 130.1 (s, 2C; CH_{Ar}, 131.2 (s, 1C; C_{q,Ar}), 131.7 (d, J=8.1, 2C; CH_{Ar}), 132.4 (d, J=2.7, CH_{Ar}), 145.7 (s, C_{q,Ar}). ¹H NMR (CDCl₃), δ_{H} (J_{H,H} and J_{H,P}), Hz) 1.20 (d, J=15.2, 9H; PtBu), 2.45 (s, 3H; CH₃), 4.48 (dd, J=6.6, J=12.7, 1H; PCH₂O), 4.60 (dd, J=6.6, J=12.7, 1H; PCH₂O), 7.35 (d, J=8.1, 2H; CH_{Ar}), 7.46-7.61 (m, 3H; CH_{Ar}), 7.76-7.83 (m, 4H; CH_{Ar}). HPLC Chiralpak IA, hexane/l-PrOH=90/10, 1.0 ml/min, tr₁=17.81, tr₂=23.46. HRMS (ESI⁺): calc. m/z 367.11275 (C₁₈H₂₄O₄PS); found m/z 367.11297. Elemental analysis: calc. (%) for C₁₈H₂₃O₄PS C 59.00; H, 6.33; found C. 58.72; H, 6.31.

1.1.6) (S_{P})−3-tert-Mesityl-1-[(tert-butyl(phenyl)phosphinooxy)methyl]imidazolium tosylate (S_{P})−7

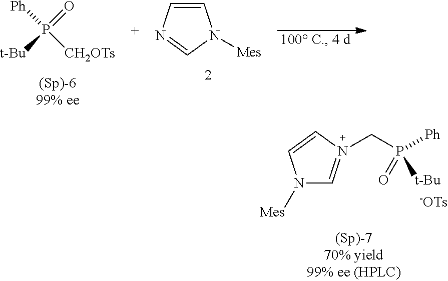

In a 50 ml one-neck flask with reflux condenser, pressure release valve and magnetic stirrer bar, 3.66 g (10 mmol) of (S_{P})-tert-butyl(phenyl)(tosylmethyl)phosphine oxide ((S_{P})−6) were admixed with 1.86 g (10 mmol) of N-mesitylimidazole (2), and the apparatus was placed under argon and heated to 100° C. for four days. The yellowish, air-stable oil formed after cooling to room temperature was diluted with a little methylene chloride and crystallized with diethyl ether. The precipitated white, very voluminous solid was filtered off and washed with diethyl ether. Yield: 3.75 g, 70%; colorless solid; ³¹P NMR (CDCl₃), δ_{P}=48.0. ¹³C NMR (CDCl₃), δ_{C} (J_{C,P}), Hz) 16.5 (s, CH₃), 17.2 (s, CH₃), 21.0 (s, CH₃), 21.3 (s, CH₃), 24.1 (s, 3C; PC(CH₃)₃), 33.2 (d, J=68.3, PC(CH₃)₃), 45.1 (d, J=55.9, PCH₂N), 122.4-143.1 (C_{Ar}+C_{solv.}). ¹H NMR (CDCl₃), δ_{H} (J_{H,H} and J_{H,P}), Hz) 1.27 (d, J=15.9, 9H; PtBu), 1.43 (s, 3H; CH₃), 1.92 (s, 3H; CH₃), 2.30 (s, 3H; CH₃), 2.33 (s, 3H; CH₃), 4.91 (dd, J=8.2, J=15.5, 1H; PCH₂N), 6.51 (d, J=15.4, 1H; PCH₂N), 6.88 (s, 1H; CH_{Ar}), 6.90 (t, J=1.5, 1H; CH_{solv.}), 6.94 (s, 1H; CH_{Ar}), 7.12 (d, J=7.8, 2H; CH_{Ar}), 7.42-7.54 (m, 3H; CH_{Ar}), 7.79 (d, J=8.1, 2H; CH_{Ar}), 7.99-8.05 (m, 2H; CH_{Ar}), 8.07 (bs, 1H; CH_{solv.}), 9.77 (s, 1H; CH_{solv.}). HPLC Cyclodex-B, ID 50 μm, L 50 cm; MeOH+40 mmol of phosphate buffer pH3+20 mmol of β-W7(beta-cyclodextrin) M1.8; 1 ml/min; tr₁=14.53, tr₂=14.89. HRMS (ESI⁺): calc. m/z 381.20903 (C₂₃H₃₀N₂OP); found m/z 381.20875. Elemental analysis: calc. (%) for C₂₁H₁₃O₅PS C, 65.20; H, 6.75; N, 5.07.; found C, 64.96; H, 6.83; N, 5.24.

1.1.7) (R_{P})−3-tert-Mesityl-1-[(tert-butyl(phenyl)phosphino)methyl]imidazolium tosylate (R_{P})−8

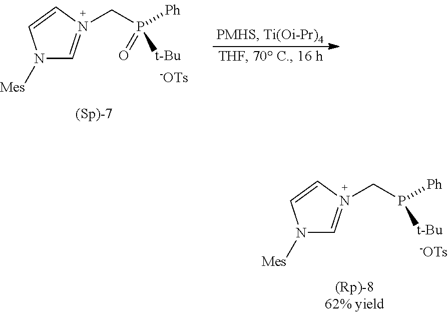

A baked-out Schlenk tube with stirrer bar was initially charged under an argon atmosphere with 3.00 g (5.4 mmol) of (S_{P})−3-tert-mesityl-1-[(tert-butyl(phenyl)phosphinooxy)methyl]imidazolium tosylate ((S_{P})−7) and 4.2 ml of poly(methylhydrosiloxane) in 20 ml of tetrahydrofuran. 1.88 ml (6.4 mmol) of titanium(IV) tetraisopropoxide were added to the reaction solution, and the reaction mixture was stirred at 70° C. overnight. For workup, after cooling to room temperature, 50 ml of hexane were added. The precipitated white solid was filtered off and washed with 20 ml of hexane. For further purification, the product was recrystallized from a mixture of dichloromethane and diethyl ether. Yield: 1.80 g, 62%; colorless solid; ³¹P NMR (CDCl₃), δ_{P}=10.1. ¹³C NMR (CDCl₃), δ_{C} (J_{C,P}), Hz) 16.8 (s, CH₃), 17.3 (s, CH₃), 21.1 (s, CH₃), 21.3 (s, CH₃), 27.4 (d, J=13.2, 3C; PC(CH₃)₃), 30.5 (d, J=11.0, PC(CH₃)₃), 44.8 (d, J=20.3, PCH₂N), 122.4-143.4 (C_{Ar}+C_{solv.}). ¹H NMR (CDCl₃), δ_{H} (J_{H, H} and J_{H,P}), Hz) 1.12 (d, J=13.0, 9H; PtBu), 1.60 (s, 3H; CH₃), 2.01 (s, 3H; CH₃), 2.31 (s, 3H; CH₃), 2.33 (s, 3H; CH₃), 5.06 (dd, J=12.4, J=14.5, 1H; PCH₂N), 5.76 (d, J=14.7, 1H; PCH₂N), 6.90 (s, 1H; CH_{Ar}), 6.95 (m, 2H; CH_{solv.}+CH_{Ar}), 7.11 (d, J=7.9, 2H; CH_{Ar}), 7.36-7.43 (m, 3H; CH_{Ar}), 7.64 (t, J=1.7, 1H; CH_{solv.}), 7.69-7.80 (m, 4H; CH_{Ar}), 10.06 (t, J=1.4, 1H; CH_{solv.}). HRMS (ESI⁺): calc. m/z 365.21411 (C₂₃H₃₀N₂P). Found m/z 365.21428.

1.2) Synthesis of (R_{P})- and (S_{P})−3-tert-butyl-1-[(tert-butyl(methyl)phosphino)methyl]-imidazolium (1S)-isoborneol-10-sulfonate 13 and (R_{P})- and (S_{P})−3-tert-butyl-1-[(tert-butyl(methyl)phosphino)methyl]imidazolium tosylate 16
1.2.1) (R_{P})-tert-Butyl(hydroxymethyl)(methyl)phosphine-borane (R_{P})−9

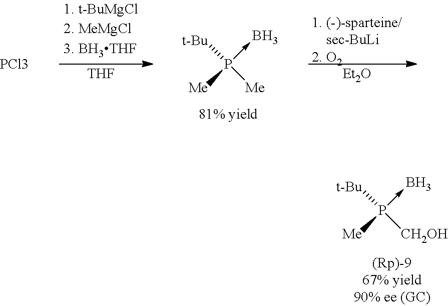

tert-Butyldimethylphosphine-borane was prepared proceeding from phosphorus trichloride by reacting with Grignard compounds and borane-THF adduct in a one-pot reaction. [I. D. Gridnev, Y. Yamanoi, N. Higashi, H. Tsuruta, M. Yasutake, T. Imamoto, Adv. Synth. Catal. 2001, 343, 118-136] (R_{P})-tert-Butyl(hydroxymethyl)(methyl)-phosphine-borane was obtained by enantioselective deprotonation with sec-butyllithium/(−)-sparteine and subsequent oxidation with atmospheric oxygen. [C. Genet, S. J. Canipa, P. O'Brien, S. Taylor, J. Am. Chem. Soc. 2006, 128, 9336-9337]
1.2.2) (S_{P})- and (R_{P})-tert-Butyl(hydroxymethyl)(methyl)phosphine oxide 10
1.2.2.1) (S_{P})-ten-Butyl(hydroxymethyl)(methyl)phosphine oxide (S_{P})−10

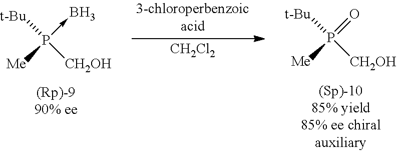

6.00 g (40.5 mmol) of (R_{P})-tert-butyl(hydroxymethyl)(methyl)phosphine-borane ((R_{P})−9) were initially charged in 225 ml of dichloromethane, and cooled to 0° C. While stirring, 40.00 g (162 mmol) of 70% 3-chloroperbenzoic acid were added in small portions within 60 minutes. The cooling was removed and the reaction suspension was stirred at room temperature for another 15 minutes. 20.44 g (162 mmol) of sodium sulfite in 150 ml of water were added to the reaction mixture, and the phases were separated in a separating funnel. The aqueous phase was extracted repeatedly with chloroform. The combined organic phases were dried over sodium sulfate, filtered and concentrated on a rotary evaporator. The crude product was applied to silica gel and purified by column chromatography (SiO₂, CHCl₃/EtOH=5/1). Yield: 5.18 g, 85%; colorless solid; ³¹P NMR (CDCl₃), δ_{P}=55.6. ¹³C NMR (CDCl₃), δ_{C} (J_{C,P}), Hz) 7.4 (d, J=64.5, PCH₃), 24.3 (s, 3C; PC(CH₃)₃), 31.2 (d, J=64.6, PC(CH₃)₃), 57.9 (d, J=72.6, PCH₂O). ¹H NMR (CDCl₃), δ_{H} (J_{H,H} and J_{H,P}), Hz) 1.19 (d, J=14.2, 9H; PtBu), 1.42 (d, J=11.7, 3H; PMe), 3.88 (dd, J=1.3, J=14.2, 1H; PCH₂O), 4.06 (dd, J=2.3, J=14.2, 1H; PCH₂O), 5.01 (bs, 1H; OH). HRMS (El⁺): calc. m/z 150.0804 (C₆H₁₅O₂P). Found m/z 150.0848. Elemental analysis: calc. (%) for C₆H₁₅O₂P C, 47.99, H, 10.07; found C. 47.83; H, 10.18.
1.2.2.2) (R_{P})-tert-Butyl(hydroxymethyl)(methyl)phosphine oxide (R_{P})−10

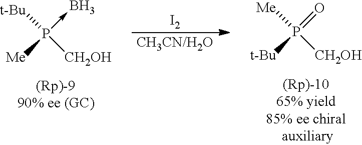

A 25 ml Schlenk tube with septum was initially charged with 75 mg (0.5 mmol) of (R_{P})-tert-butyl(hydroxymethyl)(methyl)phosphine-borane ((R_{P})−9) in 5 ml of acetonitrile, and 660 mg (2.6 mmol) of iodine and 1 ml were added. The red reaction solution was stirred at room temperature for three hours. Subsequently, 550 mg (2.5 mmol) of sodium thiosulfate and 10 ml of water were added. For workup, the reaction solution was washed in a separating funnel three times with 15 ml of ethyl acetate each time. The aqueous phase was extracted repeatedly with chloroform. The combined chloroform extracts were dried over sodium sulfate and filtered through a little silica gel. The filtrate was concentrated on a rotary evaporator and dried under reduced pressure. Yield: 50 mg, 65%; colorless solid; analytical data analogous to 1.2.2.1.

1.2.3) (S_{P})[tert-Butyl(methyl)phosphinooxymethyl](1S)-camphor-10-sulfonate (S_{P}), (1S)−11

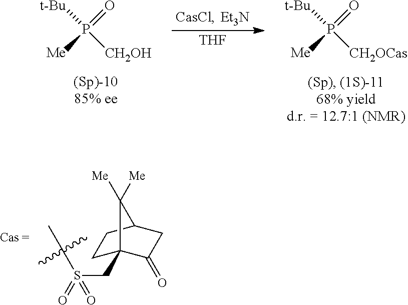

Under an argon atmosphere, a 250 ml three-neck flask with a 50 ml dropping funnel and pressure release valve was initially charged with 1.50 g (10.0 mmol) of (S_{P})-tert-butyl(hydroxymethyl)(methyl)phosphine oxide ((S_{P})−10) and 2.7 ml (19.5 mmol) of triethylamine (abs.) in 30 ml of tetrahydrofuran (abs.), and cooled to −15° C. A solution of 3.60 g (14.5 mmol) of (1S)-camphor-10-sulfonyl chloride in 20 ml of tetrahydrofuran (abs.) was added dropwise. The reaction suspension was stirred at room temperature overnight. 40 ml of water and 35 ml of dichloromethane were added to the reaction mixture, and the phases were separated in a separating funnel. The aqueous phase was extracted repeatedly with dichloromethane, and the combined organic phases were dried over sodium sulfate, filtered and concentrated on a rotary evaporator. After drying under fine vacuum, a colorless oil was obtained as the crude product, which was purified by column chromatography (SiO₂, Et₂O/EtOH=5/1). The resulting colorless oil was crystallized under cold conditions from a mixture of diethyl ether and pentane. Yield: 2.47 g, 68%; colorless solid; ³¹P NMR (CDCl₃), δ_{P}=52.5. ¹³C NMR (CDCl₃), δ_{C} (J_{C,P}), Hz) 8.5 (d, J=64.7, PCH₃), 19.6 (s, CH₃), 19.7 (s, CH₃), 24.1 (s, 3C; PC(CH₃)₃), 25.1 (s, CH₂), 26.9 (s, CH₂), 32.2 (d, J=68.9, PC(CH₃)₃), 42.5 (s, CH₂), 42.7 (s, CH), 47.3 (s, SCH₂), 48.2 (s, C_{q}), 57.9 (s, C_{q}), 63.0 (d, J=69.2, PCH₂O), 214.1 (s, C_{q}). ¹H NMR (CDCl₃), δ_{H} (J_{H,H} and J_{H,P}), Hz) 0.90 (s, 3H; CH₃), 1.11 (s, 3H; CH₃), 1.25 (d, J=15.0, 9H; PtBu), 1.41-1.52 (m, 1H; CH₂), 1.56 (d, J=12.3, 3H; PMe), 1.65-1.77 (m, 1H; CH₂), 1.97 (d, J=18.6, 1H; CH₂), 2.01-2.12 (m, 1H; CH₂), 2.15 (t, J=4.4, 1H; CH), 2.34-2.50 (m, 2H; CH₂), 3.12 (d, J=15.0, 1H; SCH₂), 3.66 (d, J=15.0, 1H; SCH₂), 4.60 (dd, J=6.7, J=13.0, 1H; PCH₂O), 4.65 (dd, J=4.8, J=13.0, 1H; PCH₂O). HRMS (FAB⁺, NBA): calc. m/z 365.1546 (C₁₆H₃₀O₅PS). Found m/z 365.1560. Elemental analysis: calc. (%) for C₁₆H₂₉O₅PS C 52.73; H, 8.02; found C. 52.75; H, 7.89.

1.2.4) (S_{P})−3-tert-Butyl-1-[(tert-butyl(methyl)phosphinooxy)methyl]imidazolium (1S)-camphor-10-sulfonate (S_{P}), (1S)−12

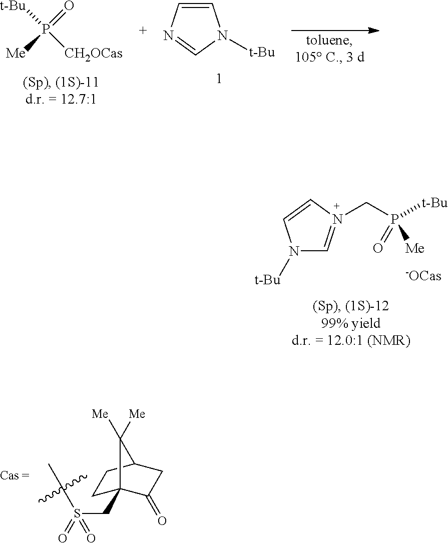

In a 100 ml Schlenk tube with pressure release valve, 6.51 g (17.8 mmol) of [(S_{P})-tert-butyl(methyl)phosphinooxymethyl] (1S)-camphor-10-sulfonate ((S_{P}), (1S)−11) and 2.44 g (19.6 mmol) of N-tert-butylimidazole (1) were stirred in 4 ml of toluene at 105° C. for 72 hours. The red-brown, viscous oil was precipitated from 50 ml of hexane in an ultrasound bath. The solids were filtered off and dried over calcium chloride under reduced pressure. Yield: 8.67 g, 99%; hygroscopic beige solid; ³9 NMR (CDCl₃), δ_{P}=54.7. ¹³C NMR (CDCl₃), δ_{C} (J_{C,P}), Hz) 8.7 (d, J=64.1, PCH₃), 19.82 (s, CH₃), 20.0 (s, CH₃), 24.0 (s, 3C; PC(CH₃)₃), 24.6 (s, CH₂), 27.1 (s, CH₂), 29.9 (s, 3C; NC(CH₃)₃), 32.1 (d, J=68.9, PC(CH₃)₃), 42.6 (s, CH), 43.0 (s, CH₂), 45.4 (d, J=56.0, PCH₂N), 47.2 (s, SCH₂), 47.9 (s, C_{q}), 58.6 (s, C_{q}), 60.7 (s, NC(CH₃)₃), 118.5 (s, CH_{solv.}), 124.1 (s, CH_{solv.}), 137.2 (d, J=2.9, CH_{solv.}), 217.1 (s, C_{q}). ¹H NMR (CDCl₃), δ_{H} (J_{H, H} and J_{H,P}), Hz) 0.83 (s, 3H; CH₃), 1.11 (s, 3H; CH₃), 1.28 (d, J=15.6, 9H; PtBu), 1.34-1.41 (m, 1H; CH₂), 1.55 (d, J=12.0, 3H; PMe), 1.72 (s, 9H; NtBu), 1.66-1.78 (m, 1H; CH₂), 1.86 (d, J=18.3, 1H; CH₂), 1.97-2.07 (m, 2H; CH+CH₂), 2.25-2.36 (m, 1H; CH₂), 2.68-2.79 (m, 1H; CH₂), 2.83 (d, J=14.7, 1H; SCH₂), 3.33 (d, J=14.7, 1H; SCH₂), 4.60 (dd, J=7.5, J=15.3, 1H; PCH₂N), 5.64 (dd, J=3.0, J=15.3, 1H; PCH₂N), 7.30 (t, J=1.9, 1H; CH_{solv.}), 7.83 (t, J=1.7, 1H; CH_{solv.}), 10.21 (bs, 1H; CH_{solv.}). HRMS (ESI⁺): calc. m/z 257.17773 (C₁₃H₂₆N₂OP). Found m/z 257.17762.

1.2.5) (R_{P})−3-tert-Butyl-1-[(tert-butyl(methyl)phosphino)methyl]imidazolium (1S)-isoborneol-10-sulfonate (R_{P}),(1S)−13

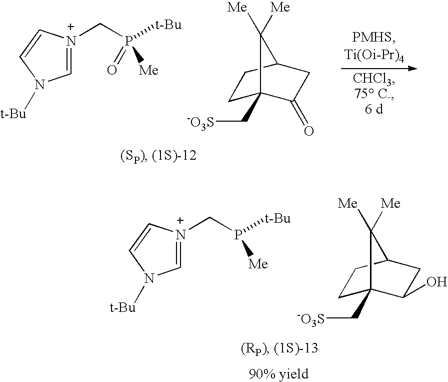

Under an argon atmosphere, a 100 ml Schlenk tube with cooling finger and pressure release valve was initially charged with 2.44 g (5.0 mmol) of (S_{P})−3-tert-butyl-1-[(tert-butyl(methyl)phosphinooxy)methyl]imidazolium (1S)-camphor-10-sulfonate ((S_{P}), (1S)−12) and 3.4 ml of poly(methylhydrosiloxane) in 20 ml of chloroform (abs.). 1.48 ml (5.0 mmol) of titanium(IV) tetraisopropoxide were added to the reaction solution, and the reaction mixture was heated to reflux at 75° C. for 6 days. After 2 days of reaction time, a further 0.50 ml (1.7 mmol, 0.3 eq.) of titanium(IV) tetraisopropoxide was added. After cooling to room temperature, the light brown solution was diluted with 20 ml of dichloromethane (abs.), and washed three times with 10 ml each time of oxygen-free saturated sodium chloride solution. The combined aqueous phases were extracted twice with 10 ml each time of dichloromethane, and the combined organic phases were dried over sodium sulfate and filtered through a protective gas frit. The desiccant was washed twice with 15 ml each time of dichloromethane. The solvents were condensed off under reduced pressure, and the yellow oil obtained was precipitated from a mixture of 20 ml of pentane (abs.) and 10 ml of hexane (abs.) in an ultrasound bath. The beige solid was filtered off and washed with hexane (abs.), and dried under fine vacuum. Yield: 2.15 g, 90%; beige solid; ³¹P NMR (CDCl₃), δ_{P}=−7.2. ¹³C NMR (CDCl₃), δ_{C} (J_{C,P}), Hz) 5.9 (d, J=18.0, PCH₃), 20.0 (s, CH₃), 20.6 (s, CH₃), 26.8 (d, J=13.0, 3C; PC(CH₃)₃), 27.5 (s, CH₂), 28.0 (d, J=9.0, PC(CH₃)₃), 30.0 (s, 3C; NC(CH₃)₃), 31.2 (s, CH₂), 38.6 (s, CH₂), 44.8 (s, CH), 47.8 (d, J=21.9, PCH₂N), 48.0 (s, C_{q}), 50.5 (s, C_{q}), 50.9 (s, SCH₂), 60.5 (s, NC(CH₃)₃), 77.2 (s, CHOH), 118.7 (s, CH_{solv.}), 121.9 (d, J=7.0, CH_{solv.}), 137.0 (s, CH_{solv.}). ¹H NMR (CDCl₃), δ_{H} (J_{H, H} and J_{H,P}), Hz) 0.79 (s, 3H; CH₃), 1.02-1.07 (m, 1H; CH₂), 1.09 (s, 3H; CH₃), 1.12 (d, J=12.4, 9H; PtBu), 1.13 (d, J=3.0, 3H; PMe), 1.62-1.84 (m, 6H; CH+CH₂), 1.72 (s, 9H; NtBu), 2.82 (d, J=14.0, 1H; SCH₂), 3.31 (d, J=13.9, 1H; SCH₂), 4.31-4.21 (m, 1H; CH), 4.62 (dd, J=5.4, J=14.5, 1H; PCH₂N), 4.74 (d, J=14.5, 1H; PCH₂N), 4.85 (bs, 1H; OH), 7.29 (t, J=1.9, 1H; CH_{solv.}), 7.44 (t, J=1.7, 1H; CH_{solv.}), 10.20 (bs, 1H; CH_{solv.}). HRMS (ESP⁺): calc. m/z 241.18281 (C₁₃H₂₆N₂P). Found m/z 241.18299. HRMS (ESI⁻): calc. m/z 233.08530 (C₁₀H₁₇O₄S). Found m/z 233.08514.

1.2.6) tert-Butyl(methyl)(tosylmethyl)phosphine oxide 14

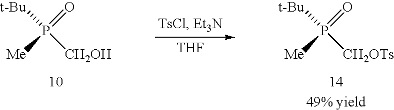

Under an argon atmosphere, a 100 ml three-neck flask with a 50 ml dropping funnel and pressure release valve was initially charged with 0.70 g (4.7 mmol) of tert-butyl(hydroxymethyl)(methyl)phosphine oxide (10) and 1.0 ml (7.0 mmol) of triethylamine (abs.) in 15 ml of tetrahydrofuran (abs.), and cooled to −15° C. A solution of 1.00 g (5.2 mmol) of tosyl chloride in 5 ml of tetrahydrofuran (abs.) was added dropwise while stirring. The reaction suspension was stirred at room temperature overnight. 10 ml of dichloromethane and 10 ml of water were added to the reaction mixture, and the phases were separated in a separating funnel. The aqueous phase was extracted repeatedly with dichloromethane. The combined organic phases were washed with 10 ml of saturated sodium chloride solution, dried over sodium sulfate, filtered and concentrated on a rotary evaporator. After drying under fine vacuum, an oil was obtained as the crude product, which was purified by column chromatography (SiO₂, CH₂Cl₂/EtOH=40/1). Yield: 0.70 g, 49%; colorless solid; ³¹P NMR (CDCl₃), δ_{P}=52.8. ¹³C NMR (CDCl₃), δ_{C} (J_{C,P}), Hz) 8.45 (d, J=64.4, PCH₃), 21.7 (s, CH₃), 24.0 (s, 3C; PC(CH₃)₃), 32.2 (d, J=68.9, PC(CH₃)₃), 62.9 (d, J=69.2, PCH₂O), 128.2 (s, 2C; CH_{Ar}), 130.1 (s, 2C; CH_{Ar}), 131.2 (s, C_{q,Ar}), 145.8 (s, C_{q,Ar}). ¹H NMR (CDCl₃), δ_{H} (J_{H, H} and J_{H,P}), Hz) 1.19 (d, J=15.3, 9H; PtBu), 1.48 (d, J=12.3, 3H; PMe), 2.47 (s, 3H; CH₃), 4.13 (dd, J=8.7, J=12.8, 1H; PCH₂O), 4.36 (dd, J=5.2, J=12.8, 1H; PCH₂O), 7.38 (d, J=8.0, 2H; CH_{Ar}), 7.80 (d, J=8.4, 2H; CH_{Ar}). HPLC Chiralpak IA, hexane/l-PrOH=90/10, 1.0 ml/min, tr₁=24.30, tr₂=25.96. HRMS (FAB⁺, NBA): calc. m/z 305.0971 (C₁₃H₂₂O₄PS). Found m/z 305.0991. Elemental analysis: calc. (%) for C₁₃H₂₁O₄PS C 51.30; H, 6.95; found C. 51.23; H, 6.99.

1.2.7) 3-tert-Butyl-1-[(tert-butyl(methyl)phosphinooxy)methyl]imidazolium tosylate 15

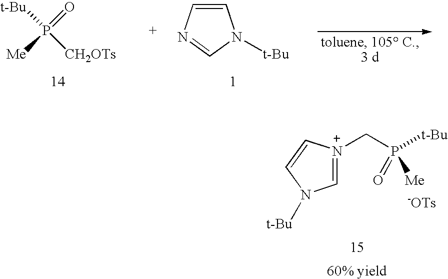

In a Schlenk tube with pressure release valve, 1.00 g (3.3 mmol) of tert-butyl(methyl)-(tosylmethyl)phosphine oxide (14) and 0.45 g (3.6 mmol) of N-tert-butylimidazole (1) were stirred in 0.7 ml of toluene at 105° C. for 72 hours. The red-brown, viscous oil was precipitated from 10 ml of hexane in an ultrasound bath. The solid was filtered off and dried over calcium chloride under reduced pressure. Yield: 0.84 g, 60%; beige solid; ³¹P NMR (CDCl₃), δ_{P}=54.6. ¹³C NMR (CDCl₃), δ_{C} (J_{C,P}), Hz) 8.7 (d, J=64.4, PCH₃), 21.3 (s, CH₃), 24.0 (s, 3C; PC(CH₃)₃), 29.9 (s, 3C; NC(CH₃)₃), 32.0 (d, J=68.6, PC(CH₃)₃), 45.4 (d, J=56.0, PCH₂N), 60.7 (s, NC(CH₃)₃), 118.7 (s, CH_{solv.}), 124.1 (s, CH_{solv.}), 125.9 (s, 2C; CH_{Ar}), 128.6 (s, 2C; CH_{Ar}), 137.0 (d, J=1.9, CH_{solv.}), 139.5 S, C_{q,Ar}) 143.1 (s, C_{q,AR}), ¹H NMR (CDCl₃), δ_{H} (J_{H,H} and J_{H,P}), Hz) 1.26 (d, J=15.8, 9H; PtBu), 1.53 (d, J=12.0, 3H; PMe), 1.70 (s, 9H; NtBu), 2.34 (s, 3H; CH₃), 4.60 (dd, J=7.6, J=15.1, 1H; PCH₂N), 5.66 (dd, J=2.8, J=15.1, 1H; PCH₂N), 7.15 (d, J=7.8, 2H; CH_{Ar}), 7.33 (t, J=1.9, 1H; CH_{solv.}), 7.78 (d, J=8.1, 2H; CH_{Ar}), 7.83 (bs, 1H; CH_{solv.}), 10.27 (bs, 1H; CH_{solv.}). HRMS (FAB⁺, NBA): calc. m/z 257.1777 (C₁₃H₂₆N₂OP). Found m/z 257.1792.

1.2.8) 3-tert-Butyl-1-[(tert-butyl(methyl)phosphino)methyl]imidazolium tosylate/chloride 16

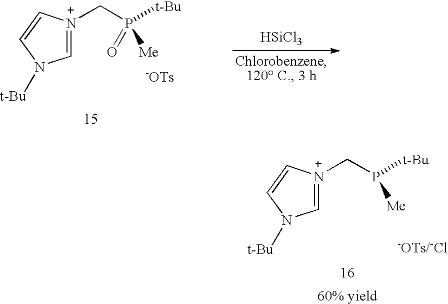

Under an argon atmosphere, 0.60 g (1.4 mmol) of 3-tert-butyl-1-[(tert-butyl(methyl)-phosphinooxy)methyl]imidazolium tosylate (15) were dissolved in 18 ml of chlorobenzene (abs.) in a baked-out 250 ml three-neck flask with dropping funnel, reflux condenser and pressure release valve, and heated to reflux at 120° C. At this temperature, 2.3 ml (2.3 mmol) of trichlorosilane were added dropwise over 1 hour, and the reaction solution was stirred at 120° C. for a further 3 hours. After cooling to room temperature, 17 ml of dichloromethane (abs.) were added, and the excess trichlorosilane was hydrolyzed at 0° C. with 50 ml of an argon-saturated 10% sodium hydroxide solution in water. The organic phase was removed, and the aqueous phase was extracted four times with 10 ml each time of dichloromethane (abs.). The combined organic phases were dried over oxygen-free sodium sulfate. After filtration, condensing off the solvent and drying under fine vacuum, a colorless solid was present, in which tosylate was partially replaced by chloride as the anion. Yield: 0.25 g, 60%; colorless solid; ³¹P NMR (CDCl₃), δ_{P}=−6.9. ¹³C NMR (CDCl₃), δ_{C} (J_{C,P}), Hz) 6.5 (d, J=18.0, PCH₃), 22.0 (s, CH₃), 27.5 (s, J=13.1, 3C; PC(CH₃)₃), 28.7 (d, J=11.1, PC(CH₃)₃), 30.7 (s, 3C; NC(CH₃)₃), 48.4 (d, J=22.2, PCH₂N), 61.2 (s, NC(CH₃)₃), 119.5 (s, CH_{solv.}), 122.6 (s, J=7.6, CH_{solv.}), 126.7 (s, 2C; CH_{Ar}), 129.2 (s, 2C; CH_{Ar}), 138.0 (d, CH_{solv.}), 139.7 (s, C_{q,Ar}), 144.6 (s, ¹H NMR (CDCl₃), δ_{H} (J_{H,H} and J_{H,P}), Hz) 1.08 (d, J=12.5, 9H; PtBu), 1.10 (d, J=2.5, 3H; PMe), 1.70 (s, 9H; NtBu), 2.34 (s, 3H; CH₃), 4.61 (dd, J=4.9, J=14.5, 1H; PCH₂N), 4.72 (d, J=14.5, 1H; PCH₂N), 7.14 (d, J=8.5, 2H; CH_{Ar}), 7.30 (t, J=1.9, 1H; CH_{solv.}), 7.44 (t, J=1.7, 1H; CH_{solv.}), 7.82 (d, J=8.2, 2H; CH_{Ar}), 10.32 (t, J=1.6, 1H; CH_{solv.}). HRMS (FAB⁺, NBA): calc. m/z 257.1828 (C₁₃H₂₆N₂P). Found m/z 241.1803.

1.3) Synthesis of (R,R)- and (S,S)−3-tert-butyl-1-[(2-c,5-t-diphenylphospholan-1-yl)methyl]imidazolium (1S)-camphor-10-sulfonate and 3-tert-butyl-1-[(2-c,5-t-diphenylphospholan-1-yl)methyl]imidazolium tosylate
1.3.1) (S,S)— and (R,R)−1-r-oxo-2-c,5-t-diphenylphospholane 18

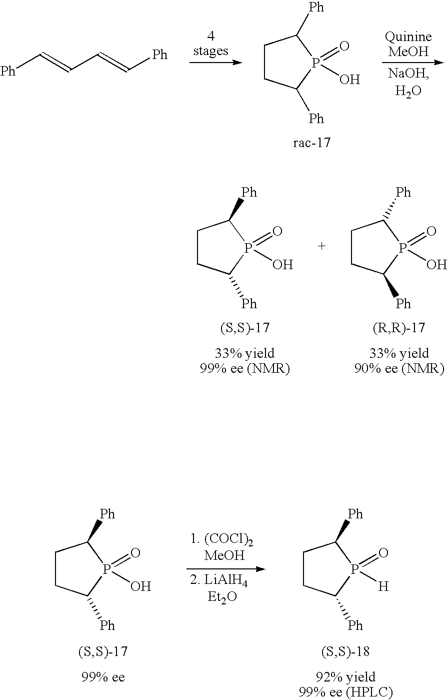

According to a literature method, rac-1-hydroxy-1-r-oxo-2-c,5-t-diphenylphospholane (17) was synthesized in four stages from (E,E)−1,4-diphenylbuta-1,3-diene. Optical resolution with quinine afforded both the (S,S)— and the (R,R)-configured enantiomer ((S,S)−17 and (R,R)−17). Chlorination with thionyl chloride and reduction with lithium aluminum hydride afforded (R,R)- and (S,S)— 1-r-oxo-2-c,5-t-diphenylphospholane ((R,R)−18 and (S,S)−18). [F. Guillen, M. Rivard, M. Toffano, J.-Y. Legros, J.-C. Daran, J.-C. Fiaud, Tetrahedron 2002, 58, 5895-5904]

1.3.2) (S,S)−1-Hydroxymethyl-1-r-oxo-2-c,5-t-diphenylphospholane (S,S)−19

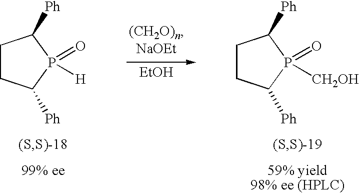

Under an argon atmosphere, a baked-out 100 ml Schlenk tube with a cold finger was initially charged with 3.91 g (15.3 mmol) of (S,S)−1-r-oxo-2-c,5-t-diphenylphospholane ((S,S)−18), 1.28 g (42.6 mmol) of paraformaldehyde and 0.12 g (1.8 mmol) of sodium ethoxide, which were suspended in 30 ml of ethanol (abs.). The reaction mixture was heated to reflux at 100° C. for 90 minutes. After cooling, the solvent was evaporated and the crude product was purified by column chromatography (SiO₂, cyclohexane/acetone first 1/1, then 1/2).

Yield: 2.57 g, 59%; colorless solid; ³¹P NMR (CDCl₃), δ_{P}=61.7. ¹³C NMR (CDCl₃), δ_{C} (J_{C,P}), Hz) 27.0 (d, J=8.5, CH₂), 31.6 (d, J=6.8, CH₂), 41.9 (d, J=58.5, CH), 48.4 (d, J=56.0, CH), 58.4 (d, J=72.9, PCH₂O), 126.9 (d, J=1.7, CH_{Ar}), 127.0 (d, J=4.2, 2C; CH_{Ar}), 127.2 (d, J=2.5, CH_{Ar}), 128.5 (s, 2C; CH_{Ar}), 129.0 (d, J=1.7, 2C; CH_{Ar}), 129.1 (d, J=5.1, 2C; CH_{Ar}), 135.2 (d, J=2.5, C_{q,Ar}), 135.9 (d, J=5.1, C_{q,Ar}). ¹H NMR (CDCl₃), δ_{H} (J_{H,H} and J_{H,P}), Hz) 2.06-2.16 (m, 1H; CH₂), 2.26-2.37 (m, 1H; CH₂), 2.37-2.50 (m, 1H; CH₂), 2.51-2.63 (m, 1H; CH₂), 3.04 (bs, 1H; OH), 3.43 (dd, J=5.3, J=14.4, 1H; PCH₂O), 3.49 (d, J=14.3, 1H; PCH₂O), 3.49 (ddd, J=7.6, J=9.9, J=12.9, 1H; CH), 3.60 (ddd, J=7.1, J=13.2, J=24.4, 1H; CH), 7.19-7.41 (m, 10H; CH_{Ar}). HPLC Chiralpak IA, hexane/l-PrOH=85/15, 1.0 ml/min, tr₁=7.79, tr₂=11.04. HRMS (FAB⁺, NBA): calc. m/z 287.1195 (C₁₇H₂₀₀O₂P). Found m/z 287.1220. Elemental analysis: calc (%) for 0171-11902P C 71.32; H, 6.69; found C. 71.22; H, 6.61.

1.3.3) (S,S)-[1-r-Oxo-2-c,5-t-diphenylphospholanomethyl] (1S)-camphor-10-sulfonate (S,S),(1S)−20

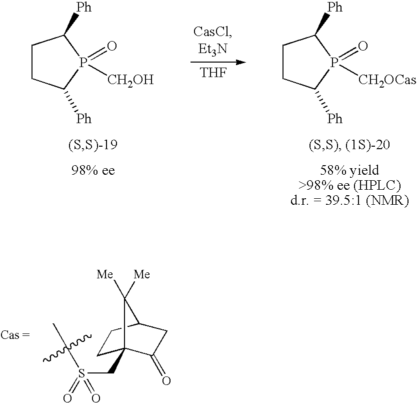

Under an argon atmosphere, a 500 ml three-neck flask with a dropping funnel and pressure release valve was initially charged with 2.30 g (8.0 mmol) of (S,S)−1-hydroxymethyl-1-r-oxo-2-c,5-t-diphenylphospholane ((S,S)−19) and 2.0 ml (14.5 mmol) of triethylamine (abs.) in 90 ml of tetrahydrofuran (abs.), and cooled to −15° C. A solution of 3.00 g (12.0 mmol) of (1S)-camphor-10-sulfonyl chloride in 30 ml of tetrahydrofuran (abs.) was slowly added dropwise. The reaction suspension was stirred at room temperature overnight. 75 ml of dichloromethane and 45 ml of water were added to the reaction mixture, and the phases were separated in a separating funnel. The aqueous phase was extracted repeatedly with dichloromethane, and the combined organic phases were dried over sodium sulfate, filtered and concentrated on a rotary evaporator. After drying under fine vacuum, the crude product is purified by column chromatography (SiO₂, Et₂O/CH₂Cl₂/acetone=30/2/1).

Yield: 2.35 g, 58%; colorless solid; ³¹P NMR (CDCl₃), δ_{P}=57.1. ¹³C NMR (CDCl₃), δ_{C} (J_{C,P}), Hz) 19.6 (s, 2C; CH₃), 24.8 (s, CH₂), 26.6 (d, J=9.1, CH₂), 26.9 (s, CH₂), 31.9 (d, J=8.2, CH₂), 42.4 (s, CH₂), 42.5 (d, J=60.5, CH), 42.7 (s, CH), 47.0 (s, SCH₂), 48.1 (s, C_{q}), 48.8 (d, J=60.5, CH), 57.7 (s, C_{q}), 62.2 (d, J=70.1, PCH₂O), 127.2 (d, J=4.8, 2C; CH_{Ar}), 127.3 (s, 2C; CH_{Ar}), 128.8 (s, 2C; CH_{Ar}), 129.1 (d, J=1.9, 2C; CH_{Ar}), 129.2 (d, J=5.3, 2C; CH_{Ar}), 134.2 (d, J=3.8, C_{q,Ar}), 134.9 (d, J=5.8, C_{q,Ar}), 213.6 (s, C_{q}). ¹H NMR (CDCl₃), δ_{H} (J_{H, H} and J_{H,P}), Hz) 0.80 (s, 3H; CH₃), 1.01 (s, 3H; CH₃), 1.36-1.48 (m, 2H; CH₂), 1.89 (d, J=18.4, 1H; CH₂), 2.00 (m, 1H; CH₂), 2.10 (t, J=4.4, 1H; CH), 2.18-2.28 (m, 2H; CH₂), 2.31-2.38 (m, 2H; CH₂), 2.42-2.56 (m, 1H; CH₂), 2.60-2.73 (m, 1H; CH₂), 2.73 (d, J=14.8, 1H; SCH₂), 3.32 (d, J=14.8, 1H; SCH₂), 3.46-3.55 (m, 1H; CH), 3.69-3.81 (m, 1H; CH), 4.18 (dd, J=4.4, J=13.2, 1H; PCH₂O), 4.38 (dd, J=8.1, J=13.0, 1H; PCH₂O), 7.27-7.45 (m, 10H, CH_{Ar}). HPLC Chiralpak IB, hexane/l-PrOH=85/15, 1.0 ml/min, tr₁=30.10, tr₂=53.27. HRMS (FAB⁺, NBA): calc. m/z 501.1859 (C₂₇H₃₄O₅PS). Found m/z 501.1826.

1.3.4) (S,S)−3-tert-Butyl-1-[(1-r-oxo-2-c,5-t-diphenylphospholan-1-yl)methyl]imidazolium (1S)-camphor-10-sulfonate (S,S),(1S)−21

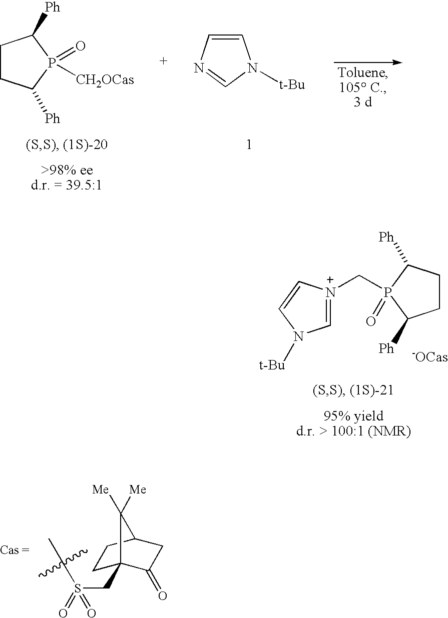

In a 50 ml Schlenk tube with a pressure release valve, 2.15 g (4.3 mmol) of (S,S)-[1-r-oxo-2-c,5-t-diphenylphospholanomethyl] (1S)-camphor-10-sulfonate ((S,S),(1S)−20) and 0.60 g (4.8 mmol) of N-tert-butylimidazole (1) were stirred in 0.7 ml of toluene at 105° C. for 72 hours. The brown, viscous oil was precipitated from 15 ml of hexane in an ultrasound bath. The solid was filtered off and dried over calcium chloride under reduced pressure.

Yield: 2.55 g, 95%; hygroscopic beige solid; ³¹P NMR (CDCl₃), δ_{P}=56.9. ¹³C NMR (CDCl₃), δ_{C} (J_{C,P}), Hz) 19.9 (s, CH₃), 20.1 (s, CH₃), 24.7 (s, CH₂), 26.9 (d, J=10.6, CH₂), 27.13 (s, CH₂), 29.8 (s, 3C; NC(CH₃)₃), 33.5 (d, J=8.2, CH₂), 42.8 (s, CH), 43.0 (s, CH₂), 44.1 (d, J=60.9, CH), 47.4 (s, SCH₂), 47.5 (d, J=56.3, PCH₂N), 47.9 (s, Cq), 49.9 (d, J=60.5, CH), 58.7 (s, Cq), 60.2 (s, NC(CH₃)₃), 117.9 (s, CH_{solv.}), 123.7 (s, CH_{solv.}), 126.9 (d, J=1.9, CH_{Ar}), 127.5 (d, J=2.9, CH_{Ar}), 128.2 (d, J=4.3, 2C; CH_{Ar}), 128.5 (s, 2C; CH_{Ar}), 129.1 (d, J=6.2, 2C; CH_{Ar}), 129.2 (d, J=1.9, 2C; CH_{Ar}), 133.9 (d, J=4.8, C_{q,Ar}), 135.9 (d, J=5.3, C_{q,Ar}), 136.6 (d, J=3.4, CH_{solv.}), 217.1 (s, Cq). ¹H NMR (CDCl₃), 6H (J_{H,H} and J_{H,P}), Hz) 0.89 (s, 3H; CH₃), 1.19 (s, 3H; CH₃), 1.37-1.44 (m, 1H; CH₂), 1.57 (s, 9H; NtBu), 1.76-1.84 (m, 1H; CH₂), 1.89 (d, J=18.1, 1H; CH₂), 2.01-2.10 (m, 2H; CH+CH₂), 2.14-2.25 (m, 1H; CH₂), 2.30-2.48 (m, 2H; CH₂), 2.64-2.79 (m, 2H; CH₂), 2.82-2.91 (m, 1H; CH₂), 2.95 (d, J=14.6, 1H; SCH₂), 3.44 (d, J=14.6, 1H; SCH₂), 3.62-3.74 (m, 1H; CH), 3.93-4.01 (m, 1H; CH), 4.35 (dd, J=7.4, J=15.4, 1H; PCH₂N), 5.37 (dd, J=4.1, J=15.4, 1H; PCH₂N), 6.90 (bs, 1H; CH_{solv.}), 7.15-7.41 (m, 8H; CH_{Ar}), 7.42 (bs, 1H; CH_{solv.}), 7.58 (d, J=7.4, 2H; CH_{Ar}), 10.05 (bs, 1H; CH_{solv.}). HRMS (ESI+): calc. m/z 393.20903 (C₂₄H₃₀N₂OP). Found m/z 393.20891.

1.3.5) (S,S)−3-tert-Butyl-1-[(2-c,5-t-diphenylphospholan-1-yl)methyl]imidazolium (1S)-camphor-10-sulfonate (S,S),(1S)−22

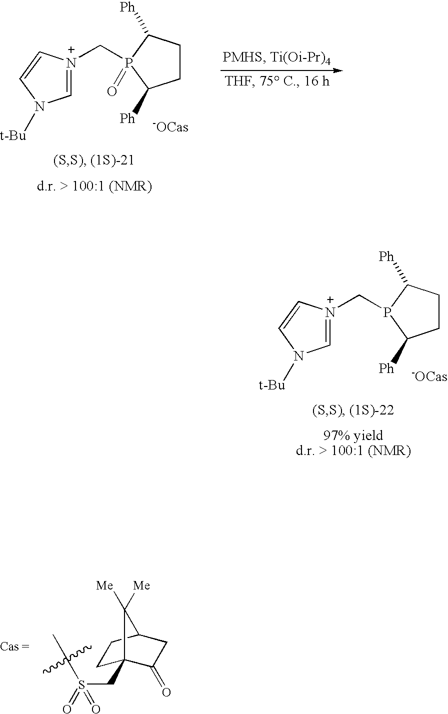

Under an argon atmosphere, a 50 ml Schlenk tube with a cold finger and pressure release valve was initially charged with 2.30 g (3.7 mmol) of (S,S)−3-tert-butyl-1-[(1-r-oxo-2-c,5-t-diphenylphospholan-1-yl)methyl]imidazolium (1S)-camphor-10-sulfonate ((S,S),(1S)−21) and 2.5 ml of poly(methylhydrosiloxane) in 18 ml of tetrahydrofuran (abs.). 1.10 ml (3.7 mmol, 1 eq.) of titanium(IV) tetraisopropoxide were added to the reaction solution, and the reaction mixture was heated to reflux at 75° C. for 16 hours. Subsequently, 60 ml of hexane (abs.) were added, and the mixture was heated to reflux at 75° C. for a further 2 hours. After cooling to room temperature, the solvents were condensed off under reduced pressure and the resulting brown oil was precipitated from hexane (abs.) in an ultrasound bath. The beige solid was filtered off and washed with hexane (abs.), and dried under fine vacuum.

Yield: 2.17 g, 97%; beige solid; ³¹P NMR (CDCl₃), δ_{P}=12.5. ¹³C NMR (CDCl₃), δ_{C} (J_{C,P}), Hz) 19.9 (s, CH₃), 20.3 (s, CH₃), 24.6 (s, CH₂), 27.1 (s, CH₂), 29.7 (s, 3C; NC(CH₃)₃), 32.0 (d, J=4.3, CH₂), 37.8 (s, CH₂), 42.7 (s, CH), 43.0 (s, CH₂), 46.4 (d, J=28.3, PCH₂N), 46.7 (d, J=14.4, CH), 47.2 (s, SCH₂), 47.8 (s, C_{q}), 47.9 (d, J=13.0, CH), 58.7 (s, C_{q}), 59.9 (s, NC(CH₃)₃), 118.1 (s, CH_{solv.}), 121.5 (d, J=7.2, CH_{solv.}), 126.2 (d, J=2.4, CH_{Ar}), 126.4 (d, J=1.4, CH_{Ar}), 127.8 (s, CH_{Ar}), 127.90 (s, 2C; CH_{Ar}), 127.92 (s, CH_{Ar}), 128.6 (s, 2C; CH_{Ar}), 128.8 (s, 2C; CH_{Ar}), 136.5 (s, CH_{solv.}), 137.0 (d, J=1.4, C_{q,Ar}), 143.4 (d, J=18.2, C_{q,Ar}), 217.0 (s, C_{q}). ¹H NMR (CDCl₃), δ_{H} (J_{H,H} and J_{H,P}), Hz) 0.87 (s, 3H; CH₃), 1.20 (s, 3H; CH₃), 1.32-1.40 (m, 1H; CH₂), 1.54 (s, 9H; NtBu), 1.72-1.79 (m, 1H; CH₂), 1.82-1.92 (m, 1H; CH₂), 1.86 (d, J=18.1, 1H; CH₂), 1.99-2.08 (m, 2H; CH+CH₂), 2.29-2.35 (m, 1H; CH₂), 2.38-2.48 (m, 1H; CH₂), 2.63-2.81 (m, 2H; CH₂), 2.87-2.96 (m, 1H; CH₂), 2.90 (d, J=14.6, 1H; SCH₂), 3.41 (d, J=14.8, 1H; SCH₂), 3.70-3.80 (m, 2H; CH), 4.56 (d, J=14.6, 1H; PCH₂N), 4.75 (dd, J=4.7, J=14.8, 1H; PCH₂N), 6.77 (s, 1H; CH_{solv.}), 6.93 (s, 1H; CH_{solv.}), 7.10-7.20 (m, 2H; CH_{Ar}), 7.25-7.33 (m, 6H; CH_{Ar}), 7.42 (d, J=7.7, 2H; CH_{Ar}), 9.63 (bs, 1H; CH_{solv.}). HRMS (ESI⁺): calc. m/z 377.21411 (C₂₄H₃₀N₂P). Found m/z 377.21431; calc. m/z 985.49788 (C₅₈H₇₅N₄O₄P₂S). Found m/z 985.49872.

1.3.6) 1-Tosylmethyl-1-r-oxo-2-c,5-t-diphenylphospholane 23

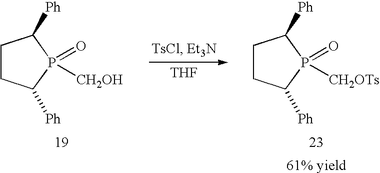

2.84 g (9.9 mmol) of 1-hydroxymethyl-1-r-oxo-2-c,5-t-diphenylphospholane (19) and 2.5 ml (18 mmol) of triethylamine were initially charged in 130 ml of tetrahydrofuran in a three-neck flask. The reaction mixture was cooled to −10° C., and a solution of 2.45 g (12.9 mmol) of tosyl chloride in 50 ml of tetrahydrofuran was added dropwise. The reaction suspension was stirred at room temperature for 16 h. After adding 50 ml of dichloromethane, the mixture was stirred at room temperature for a further four days. Subsequently, 35 ml of water were added dropwise to the reaction mixture. The phases were separated in a separating funnel, and the aqueous phase was extracted repeatedly with dichloromethane. The combined organic phases were washed with saturated sodium chloride solution, dried over sodium sulfate, filtered and concentrated on a rotary evaporator. The crude product was purified by column chromatography (SiO₂, petroleum ether/acetone=2/1).

Yield: 2.68 g, 61%; colorless solid; ³¹P NMR (CDCl₃), δ_{P}=58.5. ¹³C NMR (CDCl₃), 6c (J_{C,P}), Hz) 21.7 (s, CH₃), 26.7 (d, J=9.3, CH₂), 31.8 (d, J=8.1, CH₂), 42.1 (d, J=60.6, CH), 49.1 (d, J=60.6, CH), 61.2 (d, J=69.5, PCH₂O), 127.18 (d, J=2.5, CH_{Ar}), 127.23 (d, J=4.7, CH_{Ar}), 127.3 (d, J=2.1, CH_{Ar}), 128.0 (s, CH_{Ar}), 128.8 (s, CH_{Ar}), 128.9 (s, CH_{Ar}), 129.1 (d, J=5.5, CH_{Ar}), 130.0 (s, CH_{Ar}), 131.0 (s, C_{q,Ar}), 133.9 (d, J=3.4, C_{q,Ar}), 134.8 (d, J=5.1, C_{q,Ar}), 145.6 (s, C_{q,Ar}). ¹H NMR (CDCl₃), δ_{H} (J_{H,H} and J_{H,P}), Hz) 2.15-2.27 (m, 1H; CH₂), 2.28-2.38 (m, 1H; CH₂), 2.39-2.53 (m, 1H; CH₂), 2.45 (s, 3H; CH₃), 2.57-2.73 (m, 1H; CH₂), 3.48 (ddd, J=7.7, J=10.4, J=12.7, 1H; CH), 3.68 (ddd, J=6.9, J=13.2, J=25.9, 1H; CH), 3.72 (dd, J=6.2, J=12.7, 1H; PCH₂O), 4.05 (dd, J=9.2, J=12.6, 1H; PCH₂O), 7.23-7.41 (m, 12H; CH_{Ar}), 7.55 (d, J=8.2, 2H; CNN). HRMS (FAB⁺, NBA): calc. m/z 441.1284 (C₂₄H₂₆O₄PS). Found m/z 441.1276. Elemental analysis: calc. (%) for C₂₄H₂₅O₄PS C 65.44; H, 5.72; found C. 65.36; H, 5.56.

1.3.7) 3-tert-Butyl-1-[(1-r-oxo-2-c,5-t-diphenylphospholan-1-yl)methyl]imidazolium tosylate 24

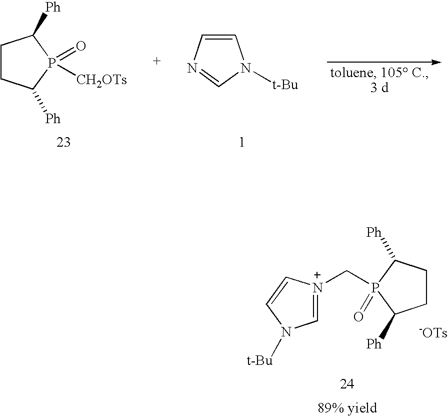

3.00 g (6.8 mmol) of 1-tosylmethyl-1-r-oxo-2-c,5-t-diphenylphospholane (23) and 0.86 g (6.9 mmol) of N-tert-butylimidazole (1) were stirred in 1 ml of toluene at 105° C. for 24 hours.

After addition of 10 ml of tetrahydrofuran and 15 ml of diethyl ether, the crude product is precipitated from the red-brown, viscous oil by treatment in an ultrasound bath and filtered off. The solid is recrystallized from tetrahydrofuran and dried over calcium chloride under reduced pressure.

Yield: 3.42 g, 89%; colorless solid; ³¹P NMR (CDCl₃), δ_{P}=57.5. ¹³C NMR (CDCl₃), δ_{C} (J_{C,P}), Hz) 21.3 (s, CH₃), 26.6 (d, J=9.7, CH₂), 29.7 (s, NC(CH₃)₃), 33.3 (d, J=7.5, CH₂), 44.1 (d, J=61.3, CH), 47.3 (d, J=55.9, PCH₂N), 49.7 (d, J=60.2, CH), 60.3 (s, NC(CH₃)₃), 118.2 (s, CH_{solv.}), 123.7 (s, CH_{solv.}), 126.0 (s, CH_{Ar}), 126.9 (s, CH_{Ar}), 127.4 (d, J=2.2, CH_{Ar}), 128.0 (d, J=4.3, CH_{Ar}), 128.5 (s, CH_{Ar}), 128.6 (s, CH_{Ar}), 129.0 (d, J=6.5, CH_{Ar}), 129.2 (d, J=2.2, CH_{Ar}), 133.7 (d, J=5.4, C_{q,Ar}), 135.7 (d, J=5.4, C_{q,Ar}), 136.0 (d, J=3.2, CH_{solv.}), 139.4 (s, C_{q,Ar}), 143.6 (s, C_{q,Ar}). ¹H NMR (CDCl₃), δ_{H} (J_{H, H} and J_{H,P}), Hz) 1.54 (s, 9H; NtBu), 2.08-2.21 (m, 1H; CH₂), 2.26-2.41 (m, 1H; CH₂), 2.35 (s, 3H; CH₃), 2.50-2.66 (m, 2H; CH₂), 3.59-3.70 (m, 1H; CH), 3.78-3.85 (m, 1H; CH), 4.35 (dd, J=7.3, J=15.4, 1H; PCH₂N), 5.22 (dd, J=4.3, J=15.4, 1H; PCH₂N), 6.96 (t, J=1.9, 1H; CH_{solv.}), 7.14-7.34 (m, 10H; CH_{Ar}), 7.40 (t, J=1.7, 1H; CH_{solv.}), 7.49 (d, J=7.6, 2H; CH_{Ar}, 7.89 (d, J=8.2, 2H; CH_{Ar}), 9.78 (bs, 1H; CH_{solv.}). HRMS (FAB⁺, NBA): calc. m/z 393.2090 (C₂₄H₃₀N₂OP). Found m/z 393.2066. Elemental analysis: calc. (%) for C₃₁H₃₇N₂O₄PS C 65.94; H, 6.60; N, 4.96; found C, 65.80; H, 6.77; N, 4.95.

1.3.8) 3-tert-Butyl-1-[(2-c,5-t-diphenylphospholan-1-yl)methyl]imidazolium tosylate 25

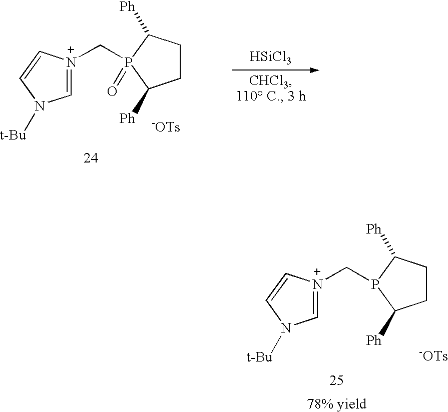

Under an argon atmosphere, a 50 ml Schlenk tube with a cold finger and pressure release valve was initially charged with 1.28 g (2.3 mmol, 1 eq.) of 3-tert-butyl-1-[(1-r-oxo-2-c,5-t-diphenylphospholan-1-yl)methyl]imidazolium tosylate (24) in 26 ml of chloroform (abs.), and 8 ml (79.1 mmol, 35 eq.) of trichlorosilane were added at room temperature. The reaction solution was heated to reflux at 110° C. while stirring for 3 hours. For workup, the excess trichlorosilane and the solvent were condensed off under reduced pressure. The residue was extracted five times with 10 ml each time of dichloromethane (abs.) and filtered through kieselguhr. The combined filtrates were concentrated under reduced pressure. The crude product was recrystallized from 5 ml of dichloromethane (abs.) by adding 30 ml of hexane. After filtration, the solid was dried under fine vacuum.

Yield: 0.97 g, 78%; colorless solid; ³¹P NMR (CD₂Cl₂), δ_{C}=12.6. ¹³C NMR (CD₂Cl₂), δ_{C} (J_{C,P}), Hz) 21.6 (s, CH₃), 30.1 (s, 3C; NC(CH₃)₃), 32.6 (s, CH₂), 38.2 (s, CH₂), 46.9 (d, J=29.7, PCH₂N), 47.1 (d, J=14.4, CH), 48.8 (d, J=14.4, CH), 60.6 (s, NC(CH₃)₃), 119.2 (s, CH_{solv.}), 122.4 (d, J=6.8, CH_{solv.}), 126.6 (s, 2C; CH_{Ar}), 126.8 (s, CH_{Ar}), 127.1 (s, CH_{Ar}), 128.47 (d, J=6.3, 2C; CH_{Ar}), 128.51 (s, 2C; CH_{Ar}), 129.2 (s, 2C; CNN), 129.3 (s, 2C; CH_{Ar}), 129.4 (s, 2C; CH_{Ar}), 136.4 (s, CH_{solv.}), 137.6 (s, C_{q,Ar}), 140.8 (s, C_{q,Ar}), 143.8 (s, CH_{solv.}), 122.4 (d, J=6.8, CH_{solv.}), 126.6 (s, 2C; CH_{Ar}), 126.8 (s, CH_{Ar}), 129.3 (s 1.82-1.93 (m, 1H; CH₂), 2.37 (s, 3H; CH₃), 2.35-2.44 (m, 1H; CH₂), 2.45-2.65 (m, 2H; CH₂), 3.53-3.63 (m, 1H; CH), 3.74-3.84 (m, 1H; CH), 4.43 (d, J=13.5, 1H; PCH₂N), 4.54 (d, J=13.1, 1H; PCH₂N), 6.83 (s, 1H; CH_{solv.}), 7.00 (s, 1H; CH_{solv.}), 7.14-7.39 (m, 12H; CH_{Ar}), 7.76 (d, J=8.2, 2H; CH_{Ar}), 9.32 (bs, 1H; CH_{solv.}). HRMS (ESI⁺): calc. m/z 377.21411 (C₂₄H₃₀ N₂P). Found m/z 377.21411, 925.44037 (C₅₅H₆₇N₄O₃P₂S). Found m/z 925.44022.

1.4) Synthesis of 3-mesityl-1-(4-methyl-(Rₐₓ)-dinaphtho[2,1-d:1′,2′-f][1,3,2]dioxa-phosphepine)imidazolium chloride 27
1.4.1) 4-Chloromethyl-(Rₐₓ)-dinaphtho[2,1-d:1′,2′-f][1,3,2]dioxaphosphepine 26

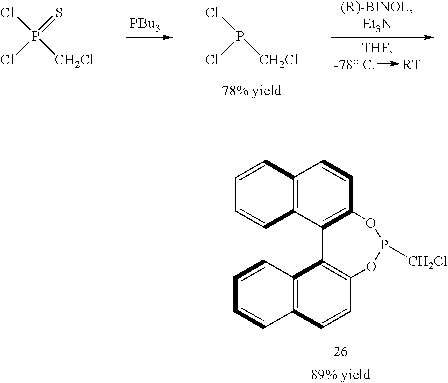

Under an argon atmosphere in a Schlenk tube, 500 mg (4.3 mmol) of triethylamine were added to a solution of 858 mg (3 mmol) of (R)-BINOL in 50 ml of THF. The reaction mixture was then cooled to −78° C. Subsequently, a solution of 453 mg (3 mmol) of ClCH₂PCl₂ in 10 ml of THF was introduced into this mixture by cannula. The reaction mixture was stirred overnight, in the course of which it warmed up to room temperature and triethylammonium chloride precipitated out as a white solid. The product was filtered off from the precipitated ammonium salt. The solvent was removed under reduced pressure.

Yield 970 mg, 89%; colorless solid; ³¹P NMR (CDCl₃), δ_{P}=179.5. ¹H NMR (CDCl₃), δ_{H} (J_{H,H}), Hz) 3.02 (m, J=4.6, J=15.4, 2H; PCH₂), 6.92-7.60 (m, 12H; CH_{Ar}). ¹³C NMR (CDCl₃), δ_{C} (J_{C,P}), Hz) 41.2 (d, J=47.9, PCH₂), 148.6-113.6 (C_{Ar}). MS (El): m/z (%): 364 (50) [M]⁺. HRMS (El): calc. m/z 364.0411 (C₂₁H₁₄O₂PCl). Found m/z 364.0413.

1.4.2) 3-Mesityl-1-(4-methyl-(Rₐₓ)-dinaphtho[2,1-d:1′,2′-f][1,3,2]dioxaphosphepine)-imidazolium chloride 27

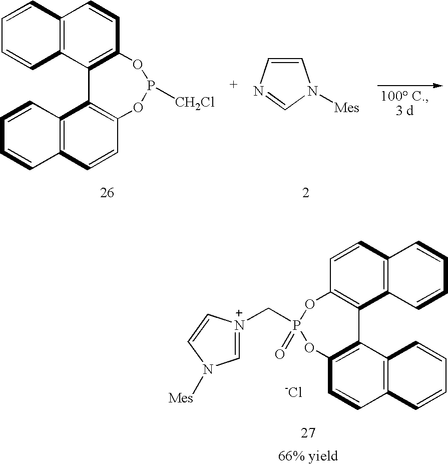

In a 25 ml one-neck flask with reflux condenser, excess pressure valve and magnetic stirrer bar, 3.64 g (10 mmol) of reagent (12) were admixed with 1.86 g (10 mmol) of N-mesitylimidazole, and the apparatus was placed under argon and heated to 100° C. for four days. The yellowish, air-stable oil which formed after cooling to room temperature was diluted with a little methylene chloride and made to crystallize with diethyl ether. The precipitated white, very voluminous solid was filtered off and washed with diethyl ether.

Yield: 3.6 g, 66%; colorless solid; ³¹P NMR (CDCl₃), δ_{P}=173.0. ¹³C NMR (CDCl₃), δ_{C} (J_{C,P}), Hz) 17.1 (s, CH₃), 20.8 (s, CH₃), 20.9 (s, CH₃), 53.2 (d, J=53.9, PCH₂N), 148.9-119.6 (CH_{solv.}+C_{Ar}). ¹H NMR (CDCl₃), δ_{H} (J_{H,H} and J_{H,P}), Hz) 1.51 (s, 3H; Me), 1.75 (s, 3H; Me), 2.16 (s, 3H; Me), 4.96 (dd, J=5.6, J=15.1; 1H; PCH₂N), 5.53 (dd, J=19.0, J=15.2, 1H; PCH₂N), 6.80-7.96 (m, 16H; CH_{solv.}+C_{Ar}), 9.74 (s, 1H; CH_{solv.}).

### 2) Synthesis of optically active ligands of the formula III

2.1) Synthesis of 3-mesityl-1-[(tert-butyl(phenyl)phosphino)methyl]imidazol-2-ylidene 28

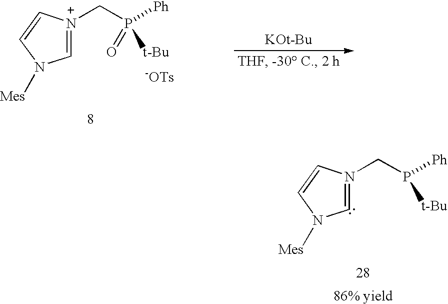

A baked-out Schlenk tube with stirrer bar was initially charged under an argon atmosphere with 300 mg (0.56 mmol) of 3-mesityl-1-[(tert-butyl(phenyl)phosphino)-methyl]imidazolium tosylate (8) together with 70 mg (0.6 mmol) of potassium tert-butoxide and cooled to −30° C. 30 ml of THF were cooled to −30° C. and transferred by cannula into the reaction mixture. The mixture was stirred for two hours, in the course of which the temperature warmed up to 0° C. Subsequently, the solvent was removed under reduced pressure at room temperature. The residue was admixed three times with 10 ml each time and twice with 5 ml each time of pentane and filtered through a baked-out frit provided with Celite. The combined pentane phases were then concentrated to dryness.

Yield: 175 mg, 86%; colorless solid; ³¹P NMR(C₆D₆), δ_{P}=14.7. ¹³C NMR(C₆D₆), δ_{C} (J_{C,P}), Hz) 17.5 (s, CH₃), 21.3 (s, CH₃), 27.9 (d, J=13.5, 3C; PC(CH₃)₃), 30.1 (d, 1JC,P=14.5, PC(CH₃)₃), 32.09 (s, CH₃), 46.6 (d, J=15.5, PCH₂N), 119.5-139.5 (14C; C_{Ar}+C_{solv.}), 216.5 (bs, NCN). ¹H NMR(C₆D₆), δ_{H} (J_{H,H}), Hz) 1.01 (d, J=12.0, 9H; PtBu), 1.21 (s, 3H; CH₃), 1.73 (s, 3H; CH₃), 2.12 (s, 3H; CH₃), 4.69 (dd, J=2.8, J=14.1, 1H; PCH₂N), 4.98 (dd, J=6.4, J=14.1, 1H; PCH₂N), 6.33 (d, J=1.3, 1H; CH_{solv.}), 6.60 (s, 1H; CH_{Ar}), 6.75 (s, 1H; CH_{Ar}), 7.05 (d, J=1.3, 1H; CH_{solv.}), 7.08-7.14 (m, 3H; CH_{Ar}), 7.53-7.60 (m, 2H; CH_{Ar}).

2.2) Synthesis of 3-tert-butyl-1-[(tert-butyl(methyl)phosphino)methyl]imidazol-2-ylidene 29

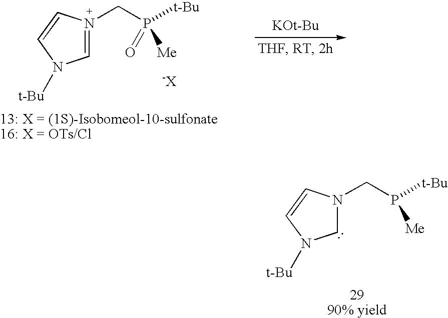

In a baked-out Schlenk tube, under an argon atmosphere, 390 μmol of 3-tert-butyl-1-[(tert-butyl(methyl)phosphino)methyl]imidazolium (1S)-isoborneol-10-sulfonate (13) or 3-tert-butyl-1-[(tert-butyl(methyl)phosphino)methyl]imidazolium tosylate/chloride (16) and 110 mg (980 μmol) of potassium tert-butoxide were suspended in 6 ml of THF. The reaction solution was stirred at room temperature for 2 hours, then the solvents were removed under reduced pressure and the residue was dried under fine vacuum for 30 minutes. The residue was admixed three times with 4 ml each time of pentane, and filtered through a baked-out, celite-filled frit. The combined pentane phases were subsequently concentrated to dryness.

Yield: 84 mg, 90%; yellow oil; ³¹P NMR(C₆D₆), δ_{P}=−15.5. ¹³C NMR(C₆D₆), δ_{C} (J_{C,P}), Hz) 6.2 (d, J=20.0, PCH₃), 27.2 (d, J=13.0, 3C; PC(CH₃)₃), 27.7 (d, J=13.0, PC(CH₃)₃), 31.7 (s, NC(CH₃)₃), 50.3 (d, J=17.0, PCH₂N), 56.1 (s, NC(CH₃)₃), 116.6 (s, CH_{solv.}), 118.8 (d, J=6.0, CH_{solv.}), 214.4 (d, J=3.0, NCN). ¹H NMR(C₆D₆), δ_{H} (J_{H,H}), Hz) 0.86 (d, J=3.4, 3H; PMe), 0.93 (d, J=11.3, 9H; PtBu), 1.47 (s, 9H; NtBu), 4.11 (dd, J=2.0, J=13.7, 1H; PCH₂N), 4.33 (dd, J=6.4, J=13.7, 1H; PCH₂N), 6.72 (d, J=2.0, 1H; CH_{solv.}), 6.93 (d, J=1.5, 1H; CH_{solv.}).

2.3) Synthesis of 3-tert-butyl-14(2-c,5-t-diphenylphospholan-1-yl)methylimidazol-2-ylidene 30

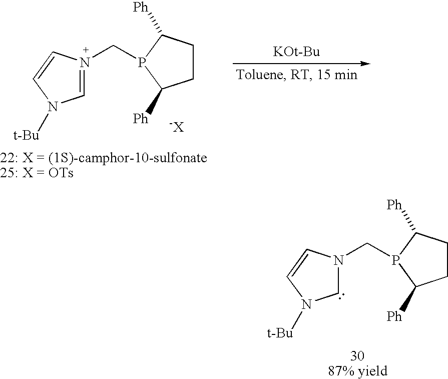

Under an argon atmosphere, in a Schlenk tube, 67 μmol of 3-tert-butyl-1-[(1-r-oxo-2-c,5-t-diphenylphospholan-1-yl)methyl]imidazolium (1S)−10-camphorsulfonate (22) or 3-tert-butyl-1-[(2-c,5-t-diphenylphospholan-1-yl)methyl]imidazolium tosylate (25) and 13.5 mg (120 μmol) of potassium tert-butoxide were suspended in 2.5 ml of toluene (abs). The reaction solution was stirred at room temperature for 15 minutes, and then 7.5 ml of pentane (abs.) were added. The precipitated solid was filtered off, and the filtrate was concentrated under reduced pressure and dried. The product is processed further directly.

Yield: 22 mg, 87%; yellow oil; ³¹P NMR(C₆D₆), δ_{P}=21.1.

### 3) Synthesis of Transition Metal Complexes of the Formula V and VI

### 3.1) Synthesis of [Pd(28)Cl₂] 31

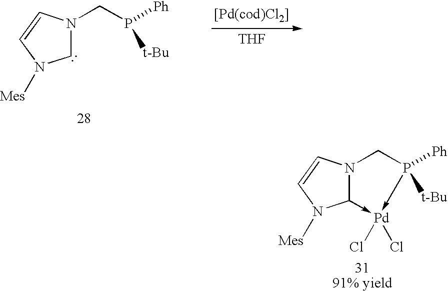

0.1 mmol of ligand 28 was dissolved in 5 ml of THF under an argon atmosphere and transferred by cannula into a suspension of 0.1 mmol of [Pd(cod)Cl₂] in 5 ml of THF. The mixture was stirred at room temperature for one day and then concentrated to dryness. Excess cod and carbene were removed by washing the resulting yellow solid with pentane and the product was dried under reduced pressure.

Yield: 50 mg, 91%; yellow crystalline solid; ³¹P NMR (CDCl₃), δ_{P}=66.1. ¹³C NMR (CDCl₃), δ_{C} (J_{C,P}), Hz) 17.7 (s, CH₃), 18.6 (s, CH₃), 21.2 (s, CH₃), 27.0 (d, J=3.5, PC(CH₃)₃), 31.2 (d, J=10.5, PC(CH₃)₃), 45.7 (d, J=33.8, PCH₂N), 138.8-125.5 (CH_{solv.}+C_{Ar}), 162.4 (s, C_{solv.}). ¹H NMR (CDCl₃), OH (J_{H,H} and J_{H,P}), Hz) 0.96 (d, J=6.6, 9H; PtBu), 1.39 (s, 3H; Me), 1.70 (s, 3H; Me), 2.02 (s, 3H; Me), 4.78 (d, J=14.8, 1H; PCH₂N), 5.41 (d, J=14.5, 1H; PCH₂N), 7.19 (s, 2H; CH_{Ar}), 7.25-7.37 (m, 5H; CH_{solv.}+CH_{Ar}), 8.09 (m, 2H; CH_{Ar}). MS (ESI): m/z (%): 505 (100) [M-Cl]⁺. HRMS (TOF MS ES): calc. m/z 505.0786 (C₂₃H₂₉N₂PPdCl). Found m/z 505.0778.

### 3.2) Synthesis of [Pt(28)Cl₂] 32

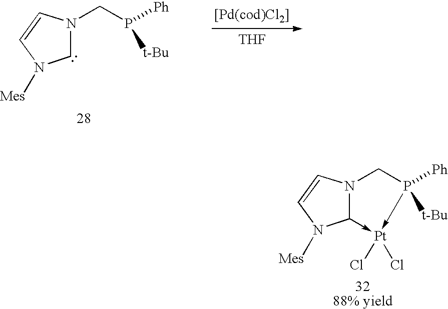

0.1 mmol of ligand 28 was dissolved in 5 ml of THF under an argon atmosphere and transferred by cannula into a suspension of 0.1 mmol of [Pt(cod)Cl₂] in 5 ml of THF. The mixture was stirred at room temperature for one day and then concentrated to dryness. Excess cod and carbene were removed by washing the resulting yellow solid with pentane and the product was dried under reduced pressure.

Yield: 55 mg, 88%; yellow crystalline solid; ³¹P NMR (CDCl₃), δ_{P} (J_{P,Pt}), Hz) 46.1. (s+sat, J=3651). ¹³C NMR (CDCl₃), δ_{C} (J_{C,P} and J_{C,P}t), Hz) 17.3 (s, CH₃), 18.4 (s, CH₃), 20.9 (s, CH₃), 26.6 (d, J=2.6, J=28.1, PC(CH₃)₃), 29.7 (d, J=3.5, J=18.1, PC(CH₃)₃), 45.3 (d, J=40.2, PCH₂N), 141.8-124.8 (CH_{solv.}+C_{Ar}), 160.5 (s, C_{solv.}). ¹H NMR (CDCl₃), 5H (J_{H,H} and J_{H,P}), Hz) 1.32 (d, J=16.9, 9H; PtBu), 1.58 (s, 3H; Me), 2.06 (s, 3H; Me), 2.22 (s, 3H; Me), 4.63 (m, 2H; PCH₂N), 7.11-8.13 (m, 9H; CH_{solv.}+CH_{Ar}). MS (ESI): m/z (%): 595 (100) [M-CI]⁺. HRMS (TOF MS ES): calc. m/z 594.1399 (C₂₃H₂₉N₂PPtCI). Found m/z 594.0505.

3.3) Synthesis of [Ni(28)(allyl)]CI 33

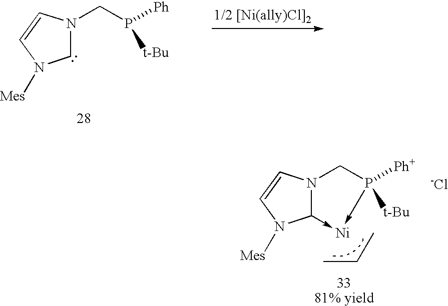

0.075 g (0.28 mmol) of [Ni(allyl)Cl]₂ and 0.212 g (0.58 mmol) of ligand 28 were weighed together into a Schlenk tube and admixed with 15 ml of hexane with stirring. After stirring at room temperature for three hours, the precipitated complex was filtered off and washed three times with 10 ml of pentane, and the product was dried under reduced pressure.

Yield: 0.227 g, 81%; yellow crystalline solid; ³¹P NMR (CDCl₃), δ_{P}=74.3 (50%), 72.4 (50%). MS (ESI): m/z (%): 463 (100) [M-CI]⁺. HRMS (TOF MS ES): calc. m/z 463.1807 (C₂₆H₃₄N₂PNi). Found m/z 463.0682.

3.4) Synthesis of [Ni(28)allyl]B(Ar^{f})₄ 34

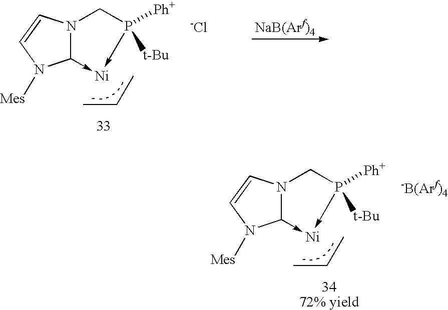

55 mg (0.11 mmol) of complex 33 and 102 mg (0.12 mmol) of NaB(Ar^{f})₄ were weighed together into a Schlenk tube and cooled to −78° C. 10 ml of diethyl ether cooled to the same temperature was transferred by cannula into this mixture with stirring and the mixture was warmed slowly up to room temperature with stirring. The solution was filtered and concentrated to dryness under reduced pressure.

Yield: 0.105 g, 72%; yellow crystalline solid; ³¹P NMR (CDCl₃), δ_{P}=78.8 (50%), 77.0 (50%). ¹³C NMR (CDCl₃), δ_{C} (J_{C,P}), Hz) 17.2 (s, CH₃), 17.4 (s, CH₃), 21.1 (s, CH₃), 26.7 (d, J=6.0, PC(CH₃)₃), 33.0 (s, PC(CH₃)₃), 46.4 (d, J=27.2, PCH₂N), 56.9 (d, J=33.4, CH_{2,allyl}), 67.5 (s, CH_{2,allyl}), 114.6 (d, J=18.1, CH_{allyl}), 140.9-117.7 (CH_{solv.}+C_{Ar}), 160.4 (s, C_{Ar}), 161.4 (s, C_{Ar}), 161.5 (s, C_{solv.}), 162.4 (s, C_{Ar}), 163.3 (s, C_{Ar}). ¹H NMR (CDCl₃), δ_{H} (J_{H,H} and J_{H,P}), Hz) 1.08 (d, J=15.8, 9H; PtBu), 1.53 (s, 3H; Me), 1.82 (s, 3H; Me), 1.91 (s, 3H; Me), 3.19 (m, 2H; CH_{2,allyl}), 4.22 (m, 2H; CH_{2,allyl}), 4.73 (m, 2H; PCH₂N), 6.93 (bs, 1H; CH_{allyl}), 7.48-7.67 (m, 12H; CH_{solv.}+CH_{Ar}). MS (ESI): m/z (%): 463 (100) [M-BAR]⁺.

### 3.5) Synthesis of [Pd(29)Me₂] 35

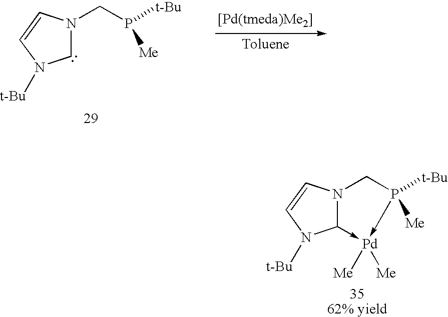

Under an argon atmosphere, a Schlenk tube was initially charged with 65 mg (257 μmol) of [Pd(tmeda)Me₂] at room temperature in 4 ml of toluene, and 68 mg (280 μmol) of 3-tert-butyl-1-[(tert-butyl(methyl)phosphino)methyl]imidazol-2-ylidene (29) in 3 ml of toluene were added dropwise. The yellow reaction solution was stirred at room temperature for 1 hour and then filtered. The product was precipitated by adding pentane, filtered, purified by washing with pentane and dried under fine vacuum.

Yield: 60 mg, 62%; beige solid; ³¹P NMR (CD₃CN), δ_{P}=47.4. ¹³C NMR (CD₃CN), δ_{C} (J_{C,P}), Hz)−5.65 (d, J=7.6, PdCH₃), 4.58 (d, J=16.1, PCH₃), 5.66 (d, J=126.3, PdCH₃), 26.3 (d, J=6.8, PC(CH₃)₃), 30.5 (d, J=7.6, PC(CH₃)₃), 31.8 (s, NC(CH₃)₃), 49.1 (d, J=22.0, PCH₂N), 58.9 (s, NC(CH₃)₃), 119.4 (d, J=4.2, CH_{solv.}), 119.8 (s, CH_{solv.}), 192.7 (d, J=8.5, C_{solv.}). ¹H NMR (CD₃CN), δ_{H} (J_{H,H}), Hz)−0.10 (d, J=8.0, 3H; PdMe), 0.01 (d, J=7.2, 3H; PdMe), 0.89 (d, J=13.1, 9H; PtBu), 1.32 (d, J=6.9, 3H; PMe), 1.71 (s, 9H; NtBu), 3.97 (dd, J=3.1, J=13.9, 1H; PCH₂N), 4.25 (dd, J=8.3, J=14.0, 1H; PCH₂N), 7.09 (d, J=1.8, 1H; CH_{solv.}), 7.17 (d, J=1.3, 1H; CH_{solv.}). HRMS (FAB⁺, NBA): calc. m/z 361.1019 (C₂₄H₂₈N₂PPd). Found m/z 361.0988.

### 3.6) Synthesis of [Pd(29)Me]BF₄ 36

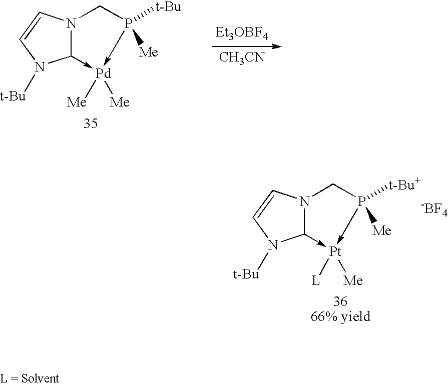

Under an argon atmosphere, 14 mg (37 μmol) of [Pd(29)Me_{2] (}35) were dissolved in 0.5 ml of acetonitrile (abs.), and 7 mg (37 μmol, 1 eq.) of triethyloxonium tetrafluoroborate were added at room temperature. After 1 hour at room temperature, the solvent was removed under reduced pressure and the residue was subsequently washed with toluene (abs.), diethyl ether (abs.) and pentane (abs.). The product was dried under fine vacuum.

Yield: 11 mg, 66%; yellow solid; ³¹P NMR (CD₃CN), δ_{P}=62.1. ¹³C NMR (CD₂Cl₂), δ_{C} (J_{C,P}), Hz)−4.19 (d, J=2.5, PdCH₃), 6.0 (d, J=34.8, PCH₃), 26.5 (d, J=4.2, PC(CH₃)₃), 31.5 (s, NC(CH₃)₃), 33.0 (d, J=28.8, PC(CH₃)₃), 48.5 (d, J=34.8, PCH₂N), 59.2 (s, NC(CH₃)₃), 119.6 (d, J=6.8, CH_{solv.}), 121.1 (s, CH_{solv.}), 186.5 (s, J=12.7, C_{solv.}). ¹H NMR (CD₃CN), δ_{H},H (J_{H,H}), Hz) 0.25 (d, J=1.9, 4H; PdMe), 1.00 (d, J=15.8, 9H; PtBu), 1.60 (d, J=11.1, 3H; PMe), 1.68 (s, 9H; NtBu), 4.30 (dd, J=14.8, J=1.5, 1H; PCH₂N), 4.51 (dd, J=14.7, J=12.7, 1H; PCH₂N), 7.18 (d, J=1.8, 1H; CH_{solv.}), 7.26 (d, J=1.9, 1H; CH_{solv.}).

### 3.7) Synthesis of [Pt(29)Me₂] 37

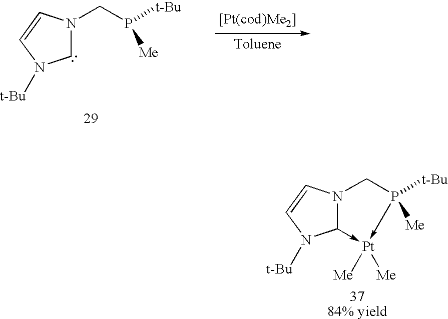

Under an argon atmosphere, a Schlenk tube was initially charged with 17 mg (50 μmol) of [(COD)PtMe₂] at room temperature in 0.5 ml of toluene, and 16 mg (67 μmol) of 3-tert-butyl-1-[(tert-butyl(methyl)phosphino)methyl]imidazol-2-ylidene (29) in 0.5 ml of toluene were added dropwise. The yellow reaction solution was stirred at room temperature for 1 hour, filtered, and concentrated and dried under reduced pressure. Washing with pentane purified the residue, which was dried under fine vacuum.

Yield: 20 mg, 84%; colorless solid; ³¹P NMR (d₈-toluene), δ_{P} (J_{P,Pt}), Hz) 51.5 (s+sat, J=1730.2). ¹H NMR (d₈-toluene), δ_{H} (J_{H,H}, J_{H,P} and J_{H,Pt}), Hz) 0.68 (d, J=13.2, 9H; PtBu), 1.09 (d+sat, J=7.0, J=66.8, 3H; PtMe), 1.13 (d+sat, J=8.1, J=24.9, 3H; PtMe), 1.35 (d+sat, J=7.3, J=71.5, 3H; PMe), 1.63 (s, 9H; NtBu), 3.14 (dd+sat, J=13.6, J=8.4, J=24.2, 1H; PCH₂N), 3.26 (dd, J=13.2, J=1.5, 1H; PCH₂N), 6.24 (d, J=1.8, 1H; CH_{solv.}), 6.43 (d, J=1.8, 1H; CH_{solv.}). HRMS (FAB⁺, NBA): calc. m/z 450.1632 (C₂₄H₂₈N₂PPt). Found m/z 450.1634.

### 3.8) Synthesis of [Pt(30)Me₂] 38

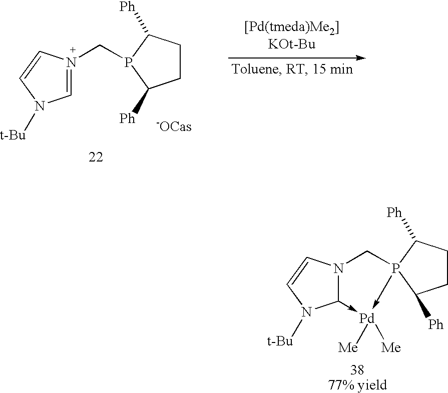

Under an argon atmosphere, 41 mg (67 μmol) of [3-tert-butyl-1-[(2-c,5-t-diphenylphospholan-1-yl)methyl]imidazolium (1S)-camphor-10-sulfonate (22), 13 mg (115 μmol) of potassium tert-butoxide and 13.5 mg (53 μmol) of [Pd(tmeda)Me₂] in 2.5 ml of toluene (abs.) were stirred at room temperature for 15 minutes. Salts are precipitated by adding 6 ml of pentane (abs.) and filtered off. The clear, pale yellowish solution is concentrated and dried under reduced pressure. The yellow residue is washed with 3 ml of pentane in an ultrasound bath, filtered and dried under fine vacuum.

Yield: 21 mg, 77%; beige solid; ³¹P NMR(C₆D₆), δ_{P}=81.2. ¹³C NMR(C₆D₆), δ_{P} (J_{C,P}), Hz)−2.7 (d, J=7.0, PdCH₃), 6.3 (d, J=127.3, PdCH₃), 31.6 (s, NC(CH₃)₃), 32.2 (d, J=3.8, CH₂), 36.1 (d, J=5.4, CH₂), 41.2 (d, J=5.9, CH), 51.0 (s, CH), 51.7 (d, J=16.1, PCH₂N), 58.3 (s, NC(CH₃)₃), 118.1 (s, CH_{solv.}), 118.1 (d, J=2.9, CH_{solv.}), 126.6 (d, J=2.2, CH_{Ar}), 127.0 (d, J=1.6, CH_{Ar}), 128.2 (d, J=1.6, 2C; CH_{Ar}), 128.6 (d, J=7.0, 2C; CH_{Ar}), 128.8 (s, 2C; CH_{Ar}), 129.4 (s, 2C, CH_{Ar}), 138.8 (d, J=4.8, C_{q,Ar}), 142.5 (d, J=9.1, C_{q,Ar}), 192.9 (s, J=8.6, C_{solv.}). ¹H NMR(C₆D₆), δ_{H}(J_{H,H}), Hz) 1.06 (d, J=7.3, 3H; PdCH₃), 1.09 (d, J=9.1, 3H; PdCH₃), 1.33 (s, 9H; NC(CH₃)₃), 1.58-1.68 (m, 1H; CH₂), 1.69-1.80 (m, 1H; CH₂), 1.89-2.07 (m, 2H; CH₂), 2.60-2.68 (m, 1H; CH), 2.98 (dd, J=8.0, J=12.4, 1H; PCH₂N), 3.32 (dd, J=7.3, J=12.4, 1H; PCH₂N), 4.00 (dd, J=12.2, J=6.6, 1H; CH), 6.01 (d, J=1.7, 1H; CH_{solv.}), 6.29 (d, J=1.5, 1H; CH_{solv.}), 6.90-7.14 (m, 8H; CH_{Ar}), 7.45 (d, J=7.6, 1H; CH_{Ar}).

### 4) Catalytic applications

4.1) 1-Hexene oligomerization with complex 11

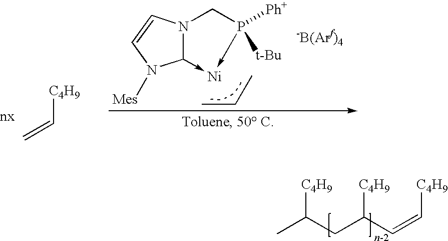

2 mg (1.5×10⁻⁶ mol) of complex 11 were added to 50 ml of toluene and 5 ml of 1-hexene in a Schlenk tube. The mixture was stirred at 50° C. for one day and the oligomers were identified by GC-MS. Dimers and trimers were identified.

4.2) Ethylene oligomerization

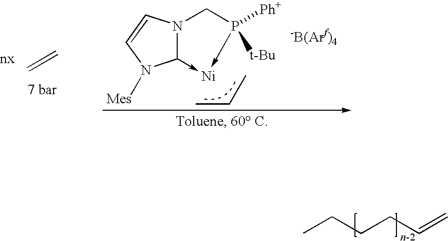

The catalyst 11 (2 mg, 1.5×10⁻⁶ mol) was weighed into an autoclave in a glovebox. 50 ml of toluene were added. The autoclave was then attached to a pressure apparatus, purged repeatedly with ethylene and stirred under the desired temperature and pressure. After the desired reaction time, the oligomerization was stopped and the autoclave was opened. The resulting solution was analyzed by means of GC-MS analysis. The oligomer distribution after 12 hours was identical to the distribution after 2 hours.

Oligomers after 2 hours (GC/MS)

| | Distribution |
|---|---|
| n | [%] |
| 2 | 16 |
| 3 | 37 |
| 4 | 34 |
| 5 | 9 |
| 6 | 3 |
| 7 | 1 |

4.3) Propylene oligomerization

The catalyst 11 (2 mg, 1.5×10⁻⁶ mol) was weighed into an autoclave in a glovebox. 50 ml of toluene were added. The autoclave was then attached to a pressure apparatus, purged repeatedly with propylene and stirred under the desired temperature and pressure. After the desired reaction time, the oligomerization was stopped and the autoclave was opened. The resulting solution was analyzed by means of GC-MS analysis. After 2 hours of reaction time, only the dimer was identified; after 24 hours of reaction time, oligomers of n=3−n=7 were identified.

4.4) Hydrogenation of methyl α-acetamidoacrylate

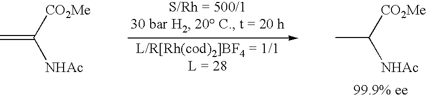

S/Rh=ratio of substrates/rhodium complex [mol/mol];

t=time;

L/[RH(cod)₂]BF₄=ratio of the NHCP ligand (L) used to the metal complex used;

ee=enantiomeric excess;

ee [%]=(enantiomer 1−enantiomer 2)/(enantiomer 1+enantiomer 2); where enantiomer 1 and enantiomer 2 represent the two possible enantiomeric products.

In a glovebox, under inert conditions, 5 ml of 2×10⁻⁶ mol of a stock solution of a ligand in CH₂Cl₂ were added to 5 ml of a solution of 2×10⁻⁶ mol of [Rh(cod)₂]BF₄ in CH₂Cl₂. The mixture was stirred at room temperature for 5 min. Subsequently, 1.0 mmol of methyl α-acetamidoacrylate in 10 ml of CH₂Cl₂ was added.

The autoclave was purged three times with hydrogen in order to remove dissolved argon. Hydrogenation was effected at 20° C. and 30 bar H₂ for 20 h. In order to remove the catalyst, the solution was applied to a short silica gel column and eluted with CH₂Cl₂. The enantiomeric excess was determined by gas chromatography.

TABLE 1

| | |
|---|---|
| | Enantiomeric |
| Ligands | excess (ee) |

Present invention

| | |
|---|---|
| 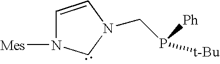 | 99.9% |
| 1/500 | |

Prior art

| | |
|---|---|
| 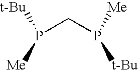 | 99.9% |
| MiniPHOS 1/500 | |
| Y. Yamanoi, T. Imamoto J. Org. | |
| Chem. 1999, 64, 2988-2989 | |
| 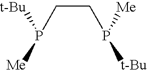 | 98% |
| BisP* 1/500 | |
| T. Imamoto, J. Watanabe, Y. Wada, | |
| H. Masuda, H. Yamada, H. Tsuruta, | |
| S. Matsukawa, K. Yamaguchi | |
| J. Am. Chem. Soc. 1998, 120, 1635- | |
| 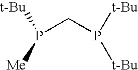 | >99% |
| 1/500 | |
| G. Hoge, H. -P. Wu, W. Kissel, D. | |
| Pflum, D. Greene, J. Bao J. Am. | |
| Chem. Soc. 2004, 126, 5966-5967 | |

The prior art ligands feature complicated syntheses, in particular of the two optical antipodes. The inventive ligands can be prepared in a simple manner and with comparable efficiencies in the form of both optical antipodes.

1. An imidazole phosphorus compound represented by formula I or II: 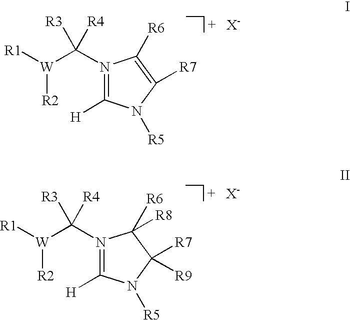
in which
W is phosphorus (P) or phosphite (P═O),
R1 and R2 are different radicals and are selected from the group consisting of alkyl and alkyl (variant α)
or
R1 and R2 are different radicals and are selected from the group consisting of alkyl and aryl (variant β),
or
R1 and R2 together with W form a chiral 7-membered ring selected from the general formulae 1 to 6 (variant γ): 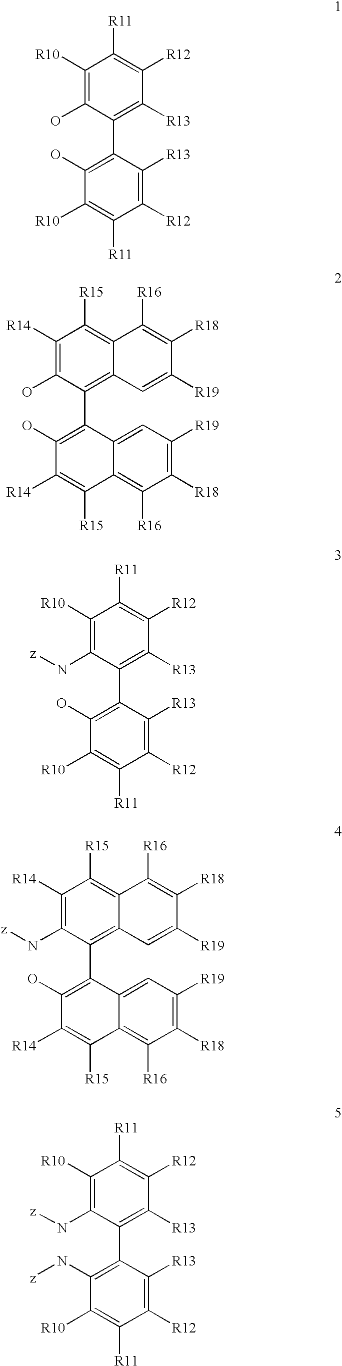 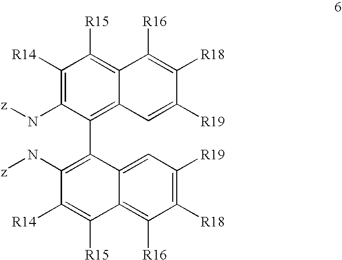
in which
R10 to R19 are each identical or different radicals and are selected from the group consisting of alkyl, aryl, alkoxy, aryloxy, acyloxy, hydroxyl, trialkylsilyl, sulfonyl, dialkylamino, acylamino, fluorine, chlorine, bromine and iodine,
or, with regard to the R12 and R13 radicals:
the adjacent R12 and R13 radicals in each case form a 5- to 6-membered saturated ring, where the 5- to 6-membered ring, as well as carbon atoms, may also comprise nitrogen or oxygen atoms in the ring skeleton,
or, in relation to the R13 radicals:
the two R13 radicals form a 7- to 12-membered ring,
z in each case represents identical or different radicals and is selected from the group consisting of hydrogen, alkyl, acetyl, trifluoroacetyl, benzoyl, tosyl and nosyl,
or
R1 and R2 together with W form a chiral 5-membered ring selected from the general formulae 7 to 9 (variant δ): 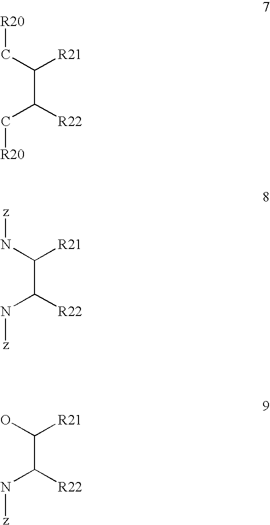
in which
R20 is a radical selected from the group consisting of methyl, ethyl, propyl, butyl, isopropyl and phenyl,
R21 and R22 are each identical or different radicals and are selected from the group consisting of hydrogen, alkyl, aryl and alkoxy,
or R21 and R22 form a 4- to 6-membered ring which, as well as carbon atoms, may have up to two oxygen atoms in the ring skeleton,
z in each case represents identical or different radicals and is selected from the group consisting of hydrogen, alkyl, acetyl, trifluoroacetyl, benzoyl, tosyl and nosyl,
R3 and R4 are each identical or different radicals selected from the group consisting of hydrogen, alkyl and aryl,
R5 is alkyl or aryl,
R6 and R7 are each identical or different radicals selected from the group consisting of hydrogen, alkyl, aryl and a 6-membered aliphatic or aromatic ring,
R8 and R9 are each independently hydrogen or alkyl, and
X is a leaving group.

2. The imidazole phosphorus compound according to claim 1,
in which
W is phosphorus (P),
in the case of variant α:
R1 is adamantyl, tert-butyl, sec-butyl or isopropyl, and R2 is methyl, ethyl, propyl, butyl, pentyl or hexyl,
in the case of variant β:
R1 is phenyl, tolyl, xylyl, mesityl, naphthyl, fluorenyl, anthracenyl, and R2 is adamantyl, tert-butyl, sec-butyl, isopropyl or methyl,
in the case of variant γ:
R10 to R19 are each identical or different radicals selected from the group consisting of alkyl, alkoxy, hydroxyl, chlorine, hydrogen and bromine,
z is independently alkyl, acetyl or tosyl,
in the case of variant δ:
R20 is methyl, ethyl or isopropyl,
R21 and R22 are each independently hydrogen or alkoxy,
z is alkyl, aryl or tosyl,
R3 and R4 are each independently hydrogen, methyl, ethyl or benzyl,
R5 is methyl, ethyl, isopropyl, tert-butyl, adamantyl, mesityl, phenyl, tolyl, xylyl, naphthyl, fluorenyl or anthracenyl,
R6 and R7 are each independently hydrogen or a 6-membered aromatic ring,
R8 and R9 are each independently hydrogen, alkyl or aryl, and
X is a leaving group.

3. The imidazole phosphorus compound according to claim 1,
in which
W is phosphorus (P),
in the case of variant α:
R1 is tert-butyl and R2 is methyl or ethyl,
in the case of variant β:
R1 is phenyl and R2 is tert-butyl or methyl,
R3 and R4 are each hydrogen,
R5 is methyl, isopropyl, tert-butyl, adamantyl or mesityl,
R6 and R7 are each independently hydrogen or a 6-membered aromatic ring,
R8 and R9 are each independently hydrogen, phenyl or a (CH₂)₄ chain,
X is a leaving group.

4. A process for preparing imidazole phosphorus compounds represented by formula I or II according to claim 1, which comprises reacting compounds represented by formula A 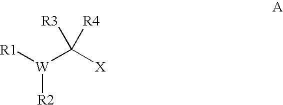
with compounds represented by formula B or C 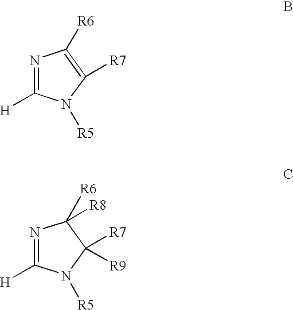
at a temperature of from 20 to 200° C. for several days, optionally in the presence of one or more solvents,
in which
W is phosphorus (P) or phosphite (P═O),
R1 and R2 are different radicals and are selected from the group consisting of alkyl and alkyl (variant α)
or
R1 and R2 are different radicals and are selected from the group consisting of alkyl and aryl (variant β),
or
R1 and R2 together with W form a chiral 7-membered ring selected from the general formulae 1 to 6 (variant γ): 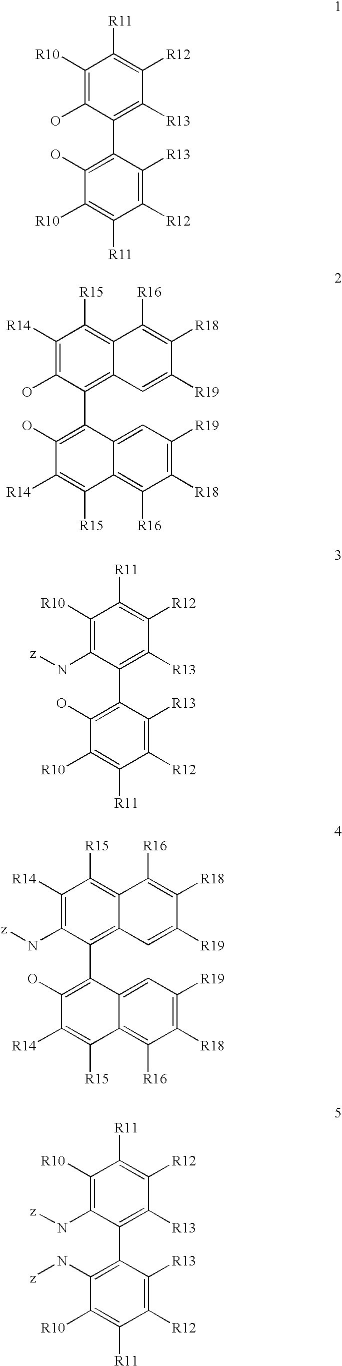 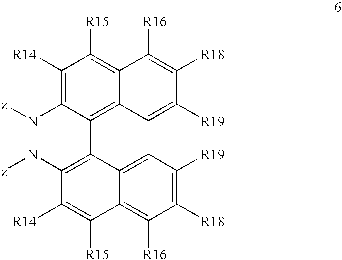
in which
R10 to R19 are each identical or different radicals and are selected from the group consisting of alkyl, aryl, alkoxy, aryloxy, acyloxy, hydroxyl, trialkylsilyl, sulfonyl, dialkylamino, acylamino, fluorine, chlorine, bromine and iodine,
or, with regard to the R12 and R13 radicals:
the adjacent R12 and R13 radicals in each case form a 5- to 6-membered saturated ring, where the 5- to 6-membered ring, as well as carbon atoms, may also comprise nitrogen or oxygen atoms in the ring skeleton,
or, in relation to the R13 radicals:
the two R13 radicals form a 7- to 12-membered ring,
z in each case represents identical or different radicals and is selected from the group consisting of hydrogen, alkyl, acetyl, trifluoroacetyl, benzoyl, tosyl and nosyl,
or
R1 and R2 together with W form a chiral 5-membered ring selected from the general formulae 7 to 9 (variant δ): 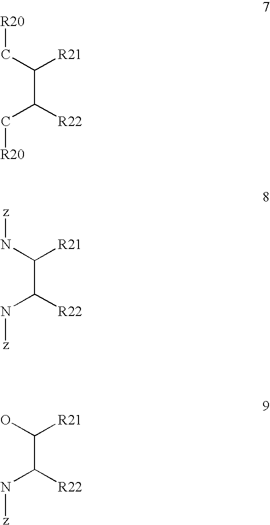
in which
R20 is a radical selected from the group consisting of methyl, ethyl, propyl, butyl, isopropyl and phenyl,
R21 and R22 are each identical or different radicals and are selected from the group consisting of hydrogen, alkyl, aryl and alkoxy,
or R21 and R22 form a 4- to 6-membered ring which, as well as carbon atoms, may have up to two oxygen atoms in the ring skeleton,
z in each case represents identical or different radicals and is selected from the group consisting of hydrogen, alkyl, acetyl, trifluoroacetyl, benzoyl, tosyl and nosyl,
R3 and R4 are each identical or different radicals selected from the group consisting of hydrogen, alkyl and aryl,
R5 is alkyl or aryl,
R6 and R7 are each identical or different radicals selected from the group consisting of hydrogen, alkyl, aryl and a 6-membered aliphatic or aromatic ring,
R8 and R9 are each independently hydrogen or alkyl,
X is a leaving group.

5. An optically active ligand represented by formula III: 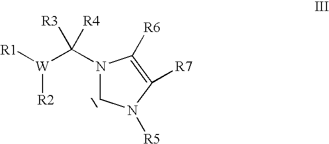
in which
W is phosphorus (P) or phosphite (P═O),
R1 and R2 are different radicals and are selected from the group consisting of alkyl and alkyl (variant α)
or
R1 and R2 are different radicals and are selected from the group consisting of alkyl and aryl (variant β),
or
R1 and R2 together with W form a chiral 7-membered ring selected from the general formulae 1 to 6 (variant γ): 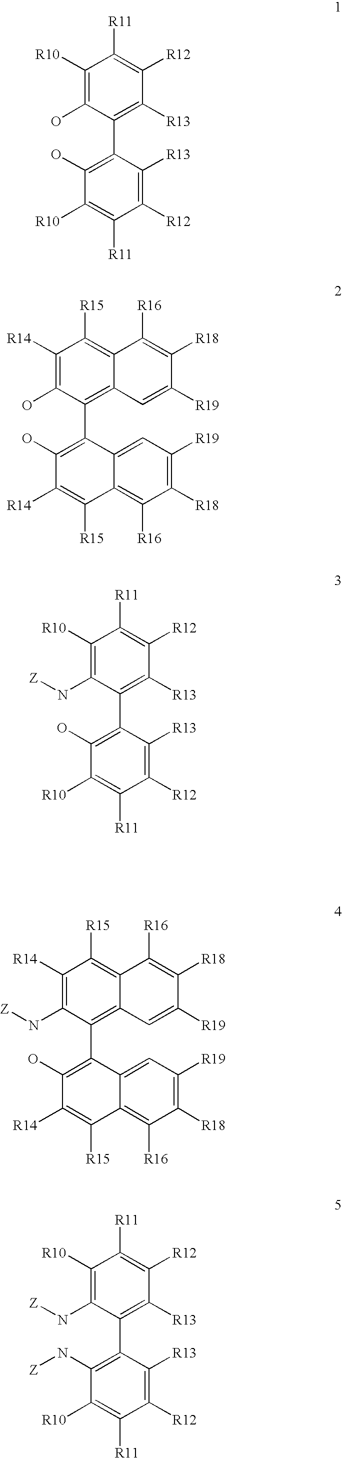 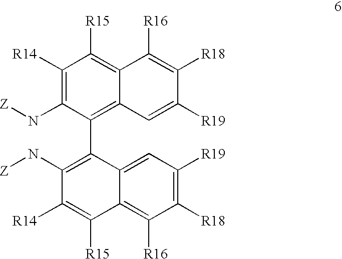
in which
R10 to R19 are each identical or different radicals and are selected from the group consisting of alkyl, aryl, alkoxy, aryloxy, acyloxy, hydroxyl, trialkylsilyl, sulfonyl, dialkylamino, acylamino, fluorine, chlorine, bromine and iodine,
or, with regard to the R12 and R13 radicals:
the adjacent R12 and R13 radicals in each case form a 5- to 6-membered saturated ring, where the 5- to 6-membered ring, as well as carbon atoms, may also comprise nitrogen or oxygen atoms in the ring skeleton,
or, in relation to the R13 radicals:
the two R13 radicals form a 7- to 12-membered ring,
z in each case represents identical or different radicals and is selected from the group consisting of hydrogen, alkyl, acetyl, trifluoroacetyl, benzoyl, tosyl and nosyl,
or
R1 and R2 together with W form a chiral 5-membered ring selected from the general formulae 7 to 9 (variant δ): 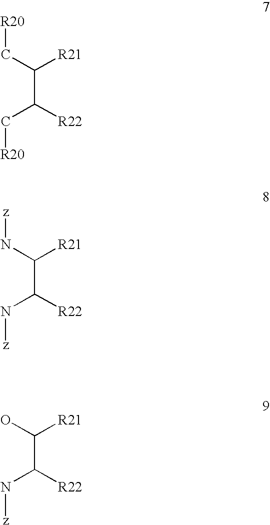
in which
R20 is a radical selected from the group consisting of methyl, ethyl, propyl, butyl, isopropyl and phenyl,
R21 and R22 are each identical or different radicals and are selected from the group consisting of hydrogen, alkyl, aryl and alkoxy,
or R21 and R22 form a 4- to 6-membered ring which, as well as carbon atoms, may have up to two oxygen atoms in the ring skeleton,
z in each case represents identical or different radicals and is selected from the group consisting of hydrogen, alkyl, acetyl, trifluoroacetyl, benzoyl, tosyl and nosyl,
R3 and R4 are each identical or different radicals selected from the group consisting of hydrogen, alkyl and aryl,
R5 is alkyl or aryl,
R6 and R7 are each identical or different radicals selected from the group consisting of hydrogen, alkyl, aryl and a 6-membered aliphatic or aromatic ring.

6. An optically active ligand according to claim 5,
in which
W is phosphorus (P),
in the case of variant α:
R1 is adamantyl, tert-butyl, sec-butyl or isopropyl, and R2 is methyl, ethyl, propyl, butyl, pentyl or hexyl,
in the case of variant β:
R1 is phenyl, tolyl, xylyl, mesityl, naphthyl, fluorenyl, anthracenyl, and R2 is adamantyl, tert-butyl, sec-butyl, isopropyl or methyl, in the case of variant γ:
R10 to R19 are each identical or different radicals selected from the group consisting of alkyl, alkoxy, hydroxyl, chlorine, hydrogen and bromine,
z is independently alkyl, acetyl or tosyl,
in the case of variant 5:
R20 is methyl, ethyl, isopropyl or phenyl,
R21 and R22 are each independently hydrogen or alkoxy,
z is alkyl, aryl or tosyl,
R3 and R4 are each independently hydrogen, methyl, ethyl or benzyl,
R5 is methyl, ethyl, isopropyl, tert-butyl, adamantyl, mesityl, phenyl, tolyl, xylyl, naphthyl, fluorenyl or anthracenyl,
R6 and R7 are each independently hydrogen or a 6-membered aromatic ring.

7. An optically active ligand according to claim 5, in which
W is phosphorus (P),
in the case of variant α:
R1 is tert-butyl and R2 is methyl or ethyl,
in the case of variant β:
R1 is phenyl and R2 is tert-butyl or methyl,
R3 and R4 are each hydrogen,
R5 is methyl, isopropyl, tert-butyl, adamantyl or mesityl,
R6 and R7 are each independently hydrogen or a 6-membered aromatic ring.

8. The compound of claim 1, wherein the compound is 3-Mesityl-1-(tert-butyl(phenyl)phosphinomethyl)imidazol-2-ylidene.

9. The compound of claim 1, wherein the compound is 3-tert-Butyl-1-(tert-butyl(methyl)phosphinomethyl)imidazol-2-ylidene.

10. The compound of claim 1, wherein the compound is 3-tert-Butyl-1-[(2-c,5-t-diphenylphospholan-1-yl)methyl]imidazol-2-ylidene.

11. The compound of claim 1, wherein the compound is 3-Mesityl-1-(4-methyldinaphtho[2,1-d:1′,2′-f][1,3,2]dioxaphosphepine)imidazol-2-ylidene.

12. A process for preparing the compound represented by formula III, which comprises converting the compounds represented by formula I according to claim 1 with at least one strong base and an ethereal or other aprotic solvent at a temperature of from −80 to +20° C. to a compound represented by formula III wherein,
if W is phosphite (P═O), optionally reducing the compounds represented by formula I before converting in the presence of in each case at least one reducing agent, of a Lewis acid and of a solvent at a temperature of +20° C. to +100° C. for from 1 to 200 hours.

13. A transition metal complex comprising, as ligands, at least one compound represented by formula III or IV 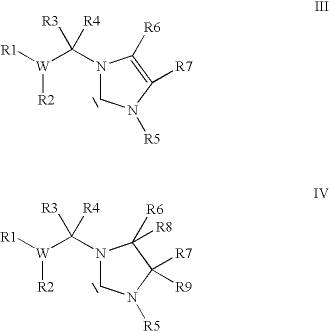
in which
W is phosphorus (P) or phosphite (P═O),
R1 and R2 are different radicals and are selected from the group consisting of alkyl and alkyl (variant α)
or
R1 and R2 are different radicals and are selected from the group consisting of alkyl and aryl (variant β),
or
R1 and R2 together with W form a chiral 7-membered ring selected from the general formulae 1 to 6 (variant γ): 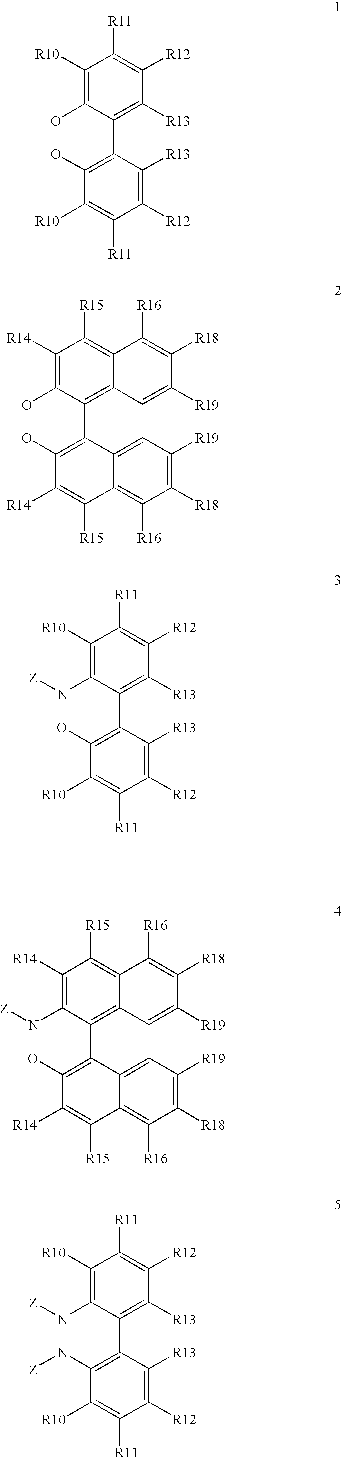 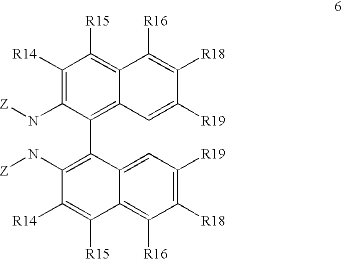
in which
R10 to R19 are each identical or different radicals and are selected from the group consisting of alkyl, aryl, alkoxy, aryloxy, acyloxy, hydroxyl, trialkylsilyl, sulfonyl, dialkylamino, acylamino, fluorine, chlorine, bromine and iodine,
or, with regard to the R12 and R13 radicals:
the adjacent R12 and R13 radicals in each case form a 5- to 6-membered saturated ring, where the 5- to 6-membered ring, as well as carbon atoms, may also comprise nitrogen or oxygen atoms in the ring skeleton,
or, in relation to the R13 radicals:
the two R13 radicals form a 7- to 12-membered ring,
z in each case represents identical or different radicals and is selected from the group consisting of hydrogen, alkyl, acetyl, trifluoroacetyl, benzoyl, tosyl and nosyl, or
R1 and R2 together with W form a chiral 5-membered ring selected from the general formulae 7 to 9 (variant δ): 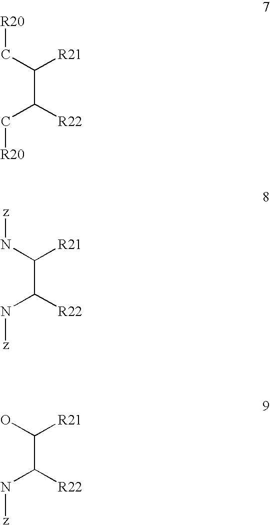
in which
R20 is a radical selected from the group consisting of methyl, ethyl, propyl, butyl, isopropyl and phenyl,
R21 and R22 are each identical or different radicals and are selected from the group consisting of hydrogen, alkyl, aryl and alkoxy,
or R21 and R22 form a 4- to 6-membered ring which, as well as carbon atoms, may have up to two oxygen atoms in the ring skeleton,
z in each case represents identical or different radicals and is selected from the group consisting of hydrogen, alkyl, acetyl, trifluoroacetyl, benzoyl, tosyl and nosyl,
R3 and R4 are each identical or different radicals selected from the group consisting of hydrogen, alkyl and aryl,
R5 is alkyl or aryl,
R6 and R7 are each identical or different radicals selected from the group consisting of hydrogen, alkyl, aryl and a 6-membered aliphatic or aromatic ring,
R8 and R9 are each independently hydrogen or alkyl.

14. A transition metal complex according to claim 13,
in which
W is phosphorus (P),
in the case of variant α:
R1 is adamantyl, tert-butyl, sec-butyl or isopropyl, and R2 is methyl, ethyl, propyl, butyl, pentyl or hexyl,
in the case of variant β:
R1 is phenyl, tolyl, xylyl, mesityl, naphthyl, fluorenyl, anthracenyl, and R2 is adamantyl, tert-butyl, sec-butyl, isopropyl or methyl,
in the case of variant γ:
R10R19 are each identical or different radicals selected from the group consisting of alkyl, alkoxy, hydroxyl, chlorine, hydrogen and bromine,
z is independently alkyl, acetyl or tosyl,
in the case of variant δ:
R20 is methyl, ethyl or isopropyl,
R21 and R22 are each independently hydrogen or alkoxy,
z is alkyl, aryl or tosyl,
R3 and R4 are each independently hydrogen, methyl, ethyl or benzyl,
R5 is methyl, ethyl, isopropyl, tert-butyl, adamantyl, mesityl, phenyl, tolyl, xylyl, naphthyl, fluorenyl or anthracenyl,
R6 and R7 are each independently hydrogen or a 6-membered aromatic ring,
R8 and R9 are each independently hydrogen, alkyl or aryl.

15. A transition metal complex according to claim 13,
in which
W is phosphorus (P),
in the case of variant α:
R1 is tert-butyl and R2 is methyl or ethyl,
in the case of variant β:
R1 is phenyl and R2 is tert-butyl or methyl,
R3 and R4 are each hydrogen,
R5 is methyl, isopropyl, tert-butyl, adamantyl or mesityl,
R6 and R7 are each independently hydrogen or a 6-membered aromatic ring,
R8 and R9 are each independently hydrogen, phenyl or a (CH₂)₄ chain.

16. A transition metal complex according to claim 13, comprising, as ligands, at least one compound selected from the group consisting of 3-mesityl-1-((R)-tert-butyl(phenyl)phosphinomethyl)imidazol-2-ylidene, 3-tert-butyl-1-((R)-tert-butyl(methyl)phosphinomethyl)imidazol-2-ylidene, 3-tert-butyl-1-[(2-c,5-t-diphenylphospholan-1-yl)methyl]imidazol-2-ylidene and 3-mesityl-1-(4-methyl-(Rₐₓ)-dinaphtho[2,1-d:1′,2′-f][1,3,2]dioxaphosphepine)imidazol-2-ylidene.

17. A transition metal complex according to claim 13, wherein the transition metal is selected from the group consisting of Ru, Fe, Co, Rh, Ir, Ni, Pd, Pt, Ag, Cu and Au.

18. A process for preparing a transition metal complex, which comprises either
(a) reacting optically active ligands represented by formula III with metal complexes at a temperature of from −80° C. to +120° C. in the presence of at least one solvent for from 5 minutes to 72 hours,
or
(b) reacting imidazole phosphorus compounds of the formula I or II with metal complexes in the presence of at least one strong base and an ethereal or other aprotic solvent at a temperature of from −80° C. to +120° C. for from 5 minutes to 72 hours,
if W is phosphite, in both cases (a) and (b), reducing the compounds of the general formula I or III in a separate preceding stage in the presence of at least one reducing agent and a Lewis acid.

19. A catalyst comprising at least one complex with a transition metal which comprises, as ligands, at least one compound represented by formula III or IV according to claim 13.

20. A catalyst according to claim 19, obtained by a process comprising reacting imidazole phosphorus compounds of the formula I or II with metal complexes in the presence of at least one strong base and an ethereal or other aprotic solvent at a temperature of from −80° C. to +120° C. for from 5 minutes to 72 hours,
if W is phosphite, reducing the compounds of the general formula I in a separate preceding stage in the presence of at least one reducing agent and a Lewis acid,
or
by reacting optically active ligands of the general formula III with metal complexes at a temperature of from −80° C. to +120° C. in the presence of at least one solvent for from 5 minutes to 72 hours,
if W is phosphite, reducing the compounds represented by formula III in a separate preceding stage in the presence of at least one reducing agent and a Lewis acid,
or
by dissolving the transition metal complexes of the formula V or VI in at least one solvent.

21-23. (canceled)
